(19) United States
(12) Patent Application Publication
(10) Pub. No.: US 2021/0317920 A1
(43) Pub. Date: Oct. 14, 2021

(54) DIVERTER AND METHOD OF USE

(71) Applicant: Todd Anthony Travis, Humble, TX (US)

(72) Inventor: Todd Anthony Travis, Humble, TX (US)

(21) Appl. No.: 16/844,308

(22) Filed: Apr. 9, 2020

(51) Int. Cl. F16K 11/085; E21B 43/26

(52) U.S. Cl. CPC F16K 11/0853; E21B 43/2607

(57) ABSTRACT

A diverter system for directing fluid from an inlet port to a selected outlet port. In one embodiment, a high-pressure fluid and proppant received from a missile can enter a diverter through an inlet port and travel to a well head via a Christmas tree or fracturing stack. The diverter system can have a plug housed in the diverter body that connects to the inlet port. The diverter body has at least one outlet port to which the plug can connect the inlet port. The plug can be configured to connect to one outlet port at a time so that a single wellhead can be singled out to experience a fracturing stage. Once the fracturing stage is complete, another wellhead can be singled out, and the previous well sealed off so that other operations can be performed.

### BACKGROUND

### Technical Field

The present disclosure relates to a diverter for conducting fracturing operations on multiple oil wells. More particularly, and not by way of limitation, the present disclosure is directed to a system and method for using a diverter that utilizes hydraulic pressure to energize the seals in the diverter and direct flow to different conduit branches connected to the diverter.

### BACKGROUND

This background section is intended to provide a discussion of related aspects of the art that could be helpful to understanding the embodiments discussed in this disclosure. It is not intended that anything contained herein be an admission of what is or is not prior art, and accordingly, this section should be considered in that light.

“Zipper” or “zip” fracturing is a process by which a single well that is located among multiple wells on the same drilling pad is isolated so that fracturing fluid can be directed exclusively into the targeted well. A well is generally not fractured in a single stage. Rather, it is fractured in multiple stages. In-between each stage, various tasks such as inserting and retracting a wireline, or a perforator gun are performed. Thus, the various equipment and personnel necessary to perform the hydraulic fracturing stages are idle while these other tasks are conducted.

An oil and gas extraction company can utilize the idle time on one well to isolate a different well on the drilling pad and fracture it while other tasks are conducted on the idle well. This allows for the personnel and equipment to continue to be utilized while other tasks are conducted on each well. Often, each well will be isolated in sequence and fractured while the other wells undergo other required activities. The result is that the waste of time and resources to completely fracture an oil and gas well is reduced considerably.

Each well in a zipper fracturing system can be isolated by a manifold comprising an arrangement of flow fitting and valves that are connected to a fracturing pump output header. The hydraulic fracture pump output header is often called a “missile.” The missile runs fracturing fluid, often a mixture of water and proppant, at an extremely high pressure into the manifold. A zipper manifold can have multiple valves operated by manual or actuated means and is often a complex assortment of handles, pipes, and valves. Traditional systems utilize multiple valves that need to be opened or closed depending on which well is the target well of a particular fracture stage. There is a risk that one of the valves will not be fully opened/closed, thus undermining the effectiveness of the fracture stage. The use of multiple valves increases the complexity, footprint, and maintenance requirements of a zipper manifold assembly.

What is needed is a system that allows for a single well to be isolated on a multi-well drill pad without a manifold. It would be advantageous to have a system and method that overcomes the disadvantages of the prior art. The present disclosure provides such a system and method.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

The present disclosure includes a unique diverter assembly that can replace a fracturing manifold. The diverter can be connected to a source of fluid pumped at an extremely high pressure such as a missile. Multiple branch pipes can be connected to the diverter through multiple outlet ports. The diverter also has an inlet port that can connect to a missile to allow for fluid to travel into the diverter. After the fluid passes through the inlet port, it enters a plug that has a fluid channel that can be shaped like an elbow. The plug can swivel so that the fluid channel is connected to a desired outlet port. In one embodiment, the fluid channel is only capable of being connected to one outlet port at a time. This allows for one of the outlet ports to be used to fracture a desired well while the other outlet ports are sealed off.

During a fracture stage, fluid can be pumped through the connected branch pipe into a fracturing stack (also referred to as a Christmas tree or frac stack) that is coupled to the targeted well. After the fracture stage of the targeted well is complete, the fluid channel in the plug is re-directed from the designated outlet port and to a different outlet port. This process of selecting a different outlet port can be accomplished by turning a joint selector using a manual mechanism or an actuator. At this point, none of the equipment has been disassembled and none of the equipment has been reassembled. The result is that a different well can now be targeted and the previously targeted well can undergo other necessary procedures before the next fracture stage is conducted.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a zipper manifold that can be found in the prior art.

FIG. 2 is a perspective environmental view of a zipper manifold that can be found in the prior art.

FIG. 3 is a side cross-section view of one embodiment of a diverter.

FIG. 4 is a detailed cross-section view of one embodiment of a diverter.

FIG. 5 is a perspective environmental view of one embodiment of a diverter implemented in a fracturing system on a multi-well drilling pad.

FIG. 6 is a schematic diagram of one embodiment of a diverter system.

FIG. 7 is a schematic diagram of an alternate embodiment of a diverter system with diverters connected in series.

FIG. 8 is a side view of a Christmas tree or fracture stack that can be utilized with a diverter.

FIG. 9 is a perspective view of an embodiment of a plug that can be utilized in a diverter.

FIG. 10 is a perspective view of an embodiment of a diverter assembly with a plug in a diverter body.

FIG. 11 is a top view of a diverter assembly.

FIG. 12 is an assembly section view of a diverter assembly.

FIG. 13 is an assembly section perspective view of a diverter assembly showing plug orientation.

FIG. 14 a side cross-section view of an alternate embodiment of a diverter assembly.

FIG. 15 is a top view of a segmented ring.

FIG. 16 is a perspective view of the segmented ring of FIG. 15.

FIG. 17 is a schematic diagram of one embodiment of a diverter system.

FIG. 18 is a schematic diagram of one embodiment of a diverter system connected to multiple fracturing trees.

FIG. 19 is a top view of a diverter system connected to two fracturing trees.

FIG. 20 is a perspective view of a diverter system connected to two fracturing trees.

FIG. 21 is a top view of a diverter system connected to multiple elbow joints.

FIG. 22 is a perspective view of a diverter system connected to multiple elbow joints.

FIG. 23 is a top view of a string of conduit that can be incorporated into a hydraulic fracturing system.

FIG. 24 is a perspective view of a string of conduit that can be incorporated into a hydraulic fracturing system.

FIG. 25 is a perspective view of one embodiment of a diverter system connected to four fracturing trees.

FIG. 26 is a top view of one embodiment of a diverter system connected to four fracturing trees.

### DETAILED DESCRIPTION

Hydrocarbon reservoirs can be located a mile or more below the surface. When a driller reaches a certain formation with the drill bit, the driller can angle the drill bit to drill horizontally to the surface. This allows the driller to target multiple parts of a formation for oil and gas exploration. The horizontal portion of a well can be drilled to a length of 5,000 feet to 10,000 feet. When the horizontal portion of the well has reached the desired length, cement casing is pumped down into the well, creating a lining around the wellbore. From there, a perforating gun can be inserted into the wellbore and positioned at a desired segment of the horizontal well. The perforating gun may contain multiple projectiles that are then fired to penetrate through the casing into the surrounding rock. Fractures are created within the oil and gas reservoir to allow the oil or gas to flow more freely into the wellbore.

After the perforation gun has been fired, it is removed out of the wellbore and then fracturing fluid can be pumped down into the well at a very high pressure. Often, the fracturing fluid is a mixture of water and other chemicals and proppant. The water penetrates the fractures in the reservoir and opens them up even wider. Once the pressure has been relieved, the proppant is left in place, propping open the fractures. These fractured conduits allow formerly trapped oil and gas to flow into the wellbore.

Next, the fracture crew begins preparation for the next stage of the fracture process. A plug and the perforation gun can be reinserted back into the wellbore. The previously fractured segment of the wellbore can be sealed off by the plug, and the perforation gun fired again, targeting a new segment of the wellbore. This creates even more fractures for formerly trapped oil and gas to flow into the wellbore. The cycle is continued until the entire desired length of the wellbore has been fractured and a sufficient number of conduits for the oil and gas in the reservoir have been created.

Between each fracture stage, maintenance and necessary preparatory tasks must be performed. For instance, after fracturing fluid is pumped into the well, the plug and perforating gun must be inserted into the wellbore. Then, once the plug seals off a previously fractured segment and the perforating gun has been fired, creating new fractures in a new segment of the reservoir, the perforating gun must be removed before fracturing fluid can be once again pumped into the wellbore. These extraction and insertion processes take time and leave the fracturing equipment and personnel idle in the meantime. To make better use of this idle time, drillers will drill multiple wells on a multi-well pad. While one well is undergoing an extraction and insertion process, the next well in the series can be undergoing high-pressure hydraulic fracturing. This way, equipment and personnel are not left idle and are utilized effectively.

A driller can connect all the wells in the series to a zipper manifold that allows for a single well in the series to be singled out for hydraulic fracturing. This process is commonly referred to as zip fracturing. Hence, the name of the zipper manifold (or fracturing manifold) is derived from the zip fracturing technique. However, zipper manifolds contain multiple valves that must be open or closed depending on which well is being targeted. The possibility that one of these valves can accidently be left open increases with the number of valves contained within the zipper manifold. Additionally, each part of the zipper manifold is another piece of equipment that can fail at a crucial time.

To reduce complexity, the manifold can be replaced with the diverter system disclosed herein. The term “zipperless” refers to the use of a diverter in place of a zipper manifold in a hydraulic fracturing system.

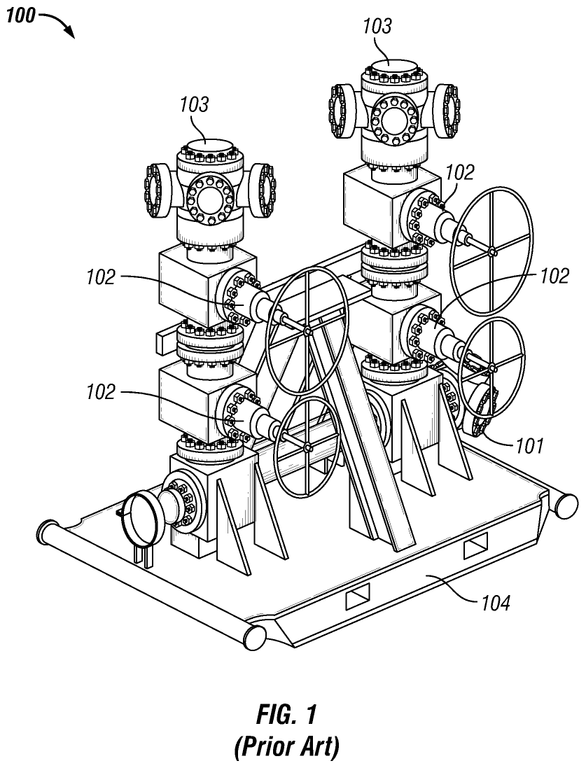

FIG. 1 is a perspective view of a zipper manifold. The zipper manifold 100 displayed in FIG. 1 is a two-leg vertical fracture manifold. To make things easier on the fracture crew moving the zipper manifold 100 into position, the zipper manifold 100 is assembled and mounted on a skid 104. Fluid can enter the zipper manifold 100 from a fluid source (not shown) through an inlet port 101. The zipper manifold 100 contains multiple gate valves 102, as well as multiple outlet ports 103. The outlet ports 103 can be connected to a fracturing stack or Christmas tree (not shown) that is mounted on a wellhead (not shown). Each part will endure wear and tear during a fracture stage and represents a potential piece of equipment that can fail at a crucial time. Furthermore, the zipper manifold 100 displayed in FIG. 1 is not the only possible configuration available for a zipper manifold. Other possible zipper manifolds can have multiple legs and have a greater number of valves and parts incorporated into the manifold.

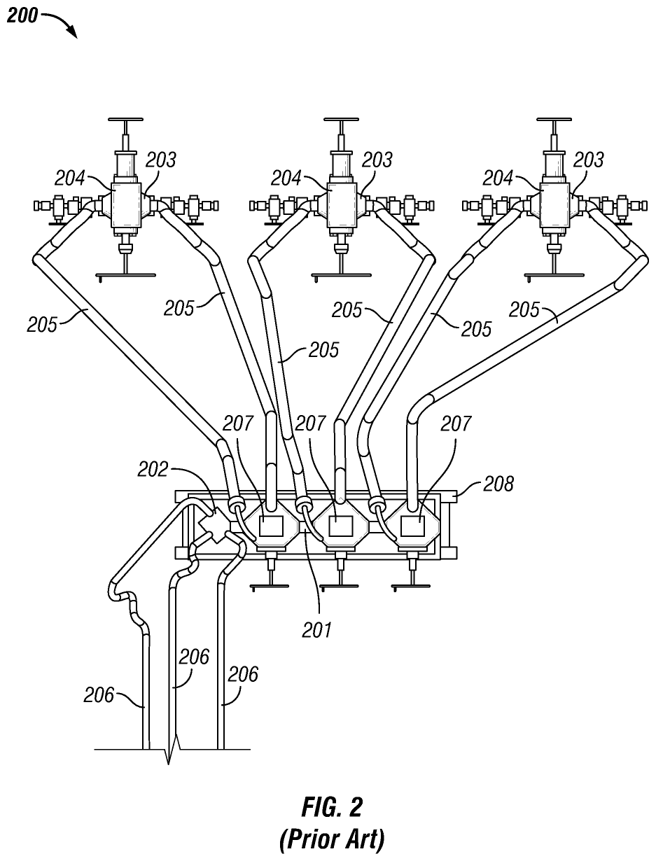

FIG. 2 is a top view of a portion of a fracturing system 200 incorporating a fracturing manifold assembly 201 into the fracturing system. Multiple wells are connected to multiple wellheads (not shown) which are each connected to a fracturing stack or Christmas tree 204. Connected to each fracturing stack or Christmas tree 204 at inlet joints 203 are branch pipes that direct fluid into the fracturing stack or Christmas tree 204. Each fracturing stack or Christmas tree 204 is connected to the fracturing manifold assembly 201. The fracturing manifold assembly 201 has a series of valves and conduits by which fracturing fluid can be directed into a specified well and is mounted on a skid 208. The fracturing manifold assembly 201 is relatively large and contains multiple valves 207. The fracturing manifold is connected to a fluid source (not shown) through a series of inlet pipes 206.

Each valve 207 is susceptible to not being properly closed. If a valve 207 is not properly closed, then fracturing fluid could be directed into a well that the fracture crew did not intend. This could result in wasted time and resources, as well as costly damage to the well itself. Furthermore, each valve 207 represents a different piece of equipment that can suffer wear and tear and ultimately fail during fracturing operations. The fracturing manifold assembly 201 can be replaced with a diverter as disclosed herein.

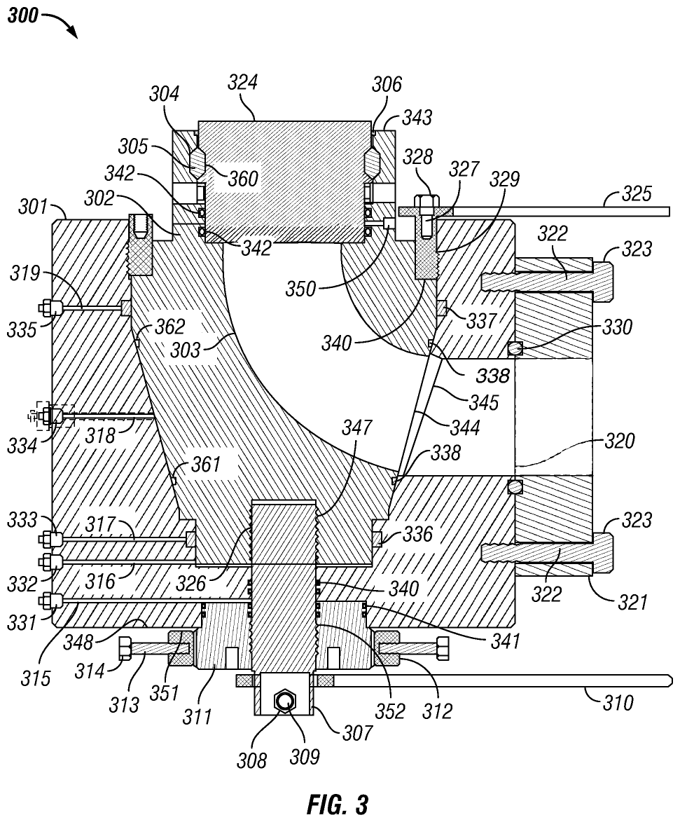

FIG. 3 is a side cross-section view of one embodiment of a diverter assembly 300. The diverter body 301 has an inlet port 306. The inlet port 306 is located at the first end 343 of the fluid chamber and can be connected to a fluid source (not shown). The fluid source can be supplied from a missile. The missile has the capacity to handle a large volume of a medium or fluid—e.g., proppant intermixed with a liquid such as water—and directing it into the diverter assembly 300. The missile can be connected to multiple pumps (usually mounted on trucks) that pump the fluid at a very high pressure into the diverter body assembly 300. However, any other means of providing the fluid source can be utilized. The diverter assembly 300 includes a test plug 324, which is also located at the first end 343 of the fluid chamber in the plug 302. The test plug 324 is removed before installation of the diverter assembly 300.

The plug port 306 has a plug groove 304. The plug groove 304 can be in the shape of an isosceles trapezoid. Housed in the plug groove 304 located in the connecting pipe (not shown) and in an inlet groove 360 with a matching isosceles trapezoid shape is a segmented load ring 305 having a matching isosceles trapezoid shape. The segmented load ring 305 is situated so that it is adjacent to the outer surface of the test plug 324 and the inner surface of the inlet port 306. The purpose of the segmented load ring 305 is to provide a load bearing surface and locking means to the inlet pipe to prevent the pipe from moving in or out when pressure is applied to the system. The hexagon shape of the segmented load ring 305 and the isosceles trapezoidal shape of the corresponding plug groove 304 and inlet groove 360 is not required. Both can have other shapes such as a rectangular shape. However, by using the hexagon shape, the force on the segmented load ring is compression instead of shear. Ideally, to put the load ring 305 in compression rather than shear, the surface of the plug groove 304 that is putting pressure on the segmented load ring 305 must be configured so that a perpendicular line can be drawn from the center of the pressure surface of the plug groove 304, across the load ring 305 to land on the opposite pressure surface of plug groove 304. By designing the load ring and corresponding plug groove 304 in this manner, when pressure is applied, compression force is applied to the load ring rather than shear force. This results in an increase in the amount of force the ring can withstand, allowing for a smaller ring to be used for a given pressure. In addition, the inlet port 306 can have multiple seals or o-rings 342 that traverse the inner surface of the inlet 306 to help create and maintain a seal. The plug/gland fluid port 350 to check for a seal at the first end 343 by applying pressure to plug/gland port 350.

In one embodiment, the plug 302 has a fluid chamber 303 that allows fluid to enter the inlet port 306 and pass through to the connected outlet port 320. As displayed in FIG. 3, the fluid chamber 303 of one embodiment has the shape of an elbow that allows for the fluid chamber 303 to connect to the outlet port 320. As shown, the connected outlet port 320 is roughly oriented perpendicular to the inlet port 306 of the plug 302, although it is not required that the outlet port 320 be perpendicular to the inlet port 306. Any number of configurations of the location of the outlet ports 320 are available to one of ordinary skill in the art.

The plug 302 can be rotated to connect the fluid chamber 303 to different outlet ports 320 located around the diverter 301. In the present invention, a diverter body 301 has at least one or more outlet ports 320, but it is not limited to any particular number. One embodiment has four outlet ports 320 positioned on opposing sides of the diverter 301. The plug 302 in the diverter body 301 has an aperture at the second end 344 of the fluid chamber 303 which can connect to each of the outlet ports 320. Disclosed in the present embodiment, the connection port 345 is a tapered cut in the diverter 301 near the second end 344 of the fluid chamber 303. However, other methods known by one of ordinary skill in the art can be used to align the second end 344 of the fluid chamber 303. Once the fluid chamber 303 is aligned with the outlet port 320 via the connection port 345, a seal can be created with the o-ring or other seal 338.

In one embodiment, the fluid aperture at the second end 344 of the fluid chamber 303 can only connect to one connection port 345 at a time. Thus, the fluid chamber 303, is only connected to one outlet port 320 via the connected outlet port 345 at a time to allow for isolation of the other outlet ports 320. The connection port can be a tapered cut out in the diverter 301 that eliminates the plug from catching on the lip that would otherwise be present if the diverter body 301 was not tapered. It may be desirable in some applications, however, to allow the diverter to connect the inlet port 306 to multiple outlet ports simultaneously. This could be accomplished by building multiple adjacent elbows into the plug 302 that would align, for example, with two outlet ports 320. But in any case, all remaining unconnected outlet ports 320 can be sealed off by o-rings or other seals built into appropriate locations on the plug 302 such that when the connection port 345 is aligned with an outlet port 320, the seals will be lined up with the unconnected outlet ports 320. As a result, in one embodiment utilizing the diverter in a fracturing system, fluid that passes through the inlet port 306 into the fluid chamber 303 and into the connected outlet port 320 can be sent only to a designated wellhead that is connected to the connected outlet port 320. All other wellheads are sealed off from the high-pressure fluid.

Once a fracturing stage is complete, the plug 302 in the diverter body 301 is reoriented to connect to a different outlet port 320. The previously selected outlet port 320 is now sealed off and fluid is no longer allowed to travel through the previously selected outlet port 320. The newly connected outlet port 320 now allows for fluid to traverse exclusively into a connected wellhead. The previously selected wellhead is closed off by operation of the diverter to select the connected wellhead and any maintenance, preparatory task, or other necessary fracturing activities can be conducted on the previously selected wellhead. The newly selected well will endure a fracture stage. This process of alternating which outlet port 320 the plug 302 is connected can be continued for multiple wells connected to different outlet ports 320 on the diverter assembly 300.

The stem 307 can be connected to the plug 302 at a stem interface 326. In the exemplary embodiment, this connection is performed by a threaded interface; however, any method for securing a plug 302 to a stem 307 known by one of ordinary skill in the art could be used to secure the plug 302 to the stem 307. The means for turning the stem 307 can be a handle 310. The handle 310 is secured to the stem 307 by a stud 309 and a nut 308. By turning the handle 310, the stem 307 turns the plug 302 to select an outlet port 320 the plug 302. While a manual handle 310 is disclosed to reorient the plug 302, one with skill in the art would understand that any other means for actuating a diverter known in the art such as a remote mechanical actuator could be used without departing from the spirit of the invention.

A flange 321 can be secured to the exit aperture of each outlet port 320. Each flange 321 can be connected to a pipe (not shown) from a wellhead. Each flange is secured to the diverter body 301 by means of flange bolts 322. Alternatively, the studs 322 along with nuts 323 can be used to secure the flange 321. Each flange 321 can be connected to a connector pipe (not shown) which can be connected to a Christmas tree or fracturing tree that is connected to a wellhead. Each outlet port 320 can have an outlet seal 330 that is housed adjacent to the flange 321 and the outlet port 320 to create a seal.

The diverter body 301 has a plurality of plug/gland fluid ports 331, 332, 333, 334, 335 that connects to a corresponding channel 315, 316, 317, 318, 319. Inside each channel 315, 316, 317, 318, 319 is a medium. In one embodiment, the medium is an energizing fluid such as hydraulic fluid that allows for pressure to be communicated to the plug 302 when a fracture crew pressures up on a plug/gland fluid port 331, 332, 333, 334, 335. Pressure is then communicated to the plug 302. Applying hydraulic pressure to certain fluid ports in sequence can be used to facilitate the reorientation of the plug 302. In the present embodiment, fluid ports 331, 332 are the fluid ports that can be utilized to raise and lower the plug 302 during the sealing and reorienting process. The other fluid ports 333, 334, 335 can be used to test the seals, to serve as wash ports and/or energize the seals. If there is residue such as sand present in the plug 302 and diverter body 301, the wash ports 334 can be used to push a fluid into the diverter body 301 to flush out this space which has been created when the plug 302 has been lifted during the reorientation process.

Applying pressure to the first fluid port 331, the stem 307 is pulled down by hydraulic pressure applied between the body 301 and the piston 311. Because the piston 311 is joined to the stem 307, which is joined to the plug 302, a downward force is applied to the plug 302. The force creates a gap between the lock ring interface 351 and the base surface 348 of the diverter body 301. This gap can be approximately ⅜ths of an inch in one embodiment. Then the lock ring 312, which is threaded to piston 311, can be turned until the lock ring interface 351 and the base surface 348 make contact, thus locking the plug 302 down. Following, the hand wheel 325 secured by an attachment stud 327 and nut 328 can be turned until the bonnet nut 329, which is circular with threads on an outer diameter mated to threads in the body 301, bottoms out on the plug 302 at the bonnet interface 340. When the pressure is released on the first plug/gland fluid port 331, the plug 302 is held in place because it is locked down by the bonnet nut 329 and the lock ring 312 and everything is sealed after it has been locked down. Both locking mechanisms are not required to seal the plug.

To re-orient the plug 302, pressure is again applied to the plug/gland port fluid 331. If pressure is applied that is approximately 10 psi higher than what was initially applied, this will allow the lock ring 312 and the bonnet nut 329 to be more easily unlocked. Once unlocked, the lock ring 312 and the wheel handle 325 can be loosened to allow enough play that the piston 311 can be moved upwards approximately ⅜ths of an inch. The piston 311 will not rise automatically due to the weight of the plug 302. Pressure can then be applied to plug/gland fluid port 332, which applies pressure to the bottom of plug 302, causing it to rise. The plug 302 will continue to rise until the bonnet nut 329 or the lock ring 312 bottom out.

With the plug raised approximately ⅜″, the plug 302 can be turned without any contact between the mating surface and the o-ring or other seal 338 such that the o-ring or other seal 338 is not damaged when crossing an outlet port. After the plug 302 is repositioned by turning the stem 307 using handle 310, the process of sealing the plug 302 by applying pressure to pull the plug 302 down and lock it in place is then repeated. Prior to turning, the o-ring or other seal 338, which could be an elastomer seal, can be de-energized by relieving the pressure and taking the squeezing force off the seal. This reduces the risk of damage to the seal. After the plug 302 is set, the o-ring or other seal 338 can be pressured/squeezed again to re-energize.

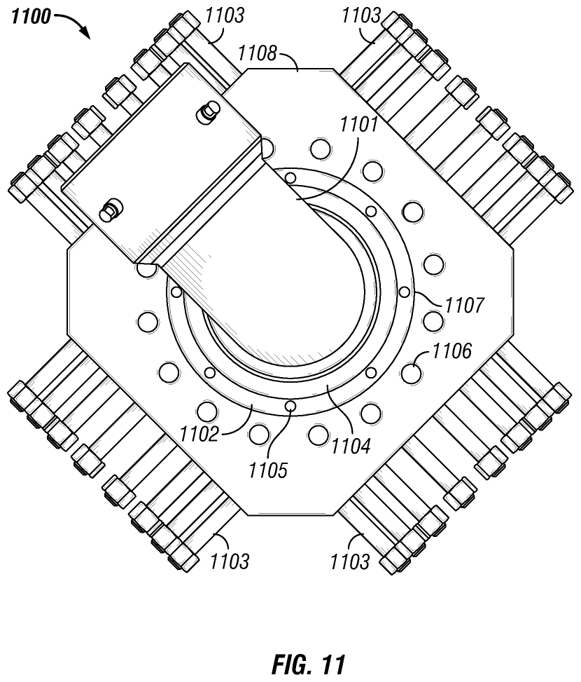

To detect when the plug 302 has been correctly aligned with the correct outlet port, a first spring pin (not shown) can be inserted into one of the holes 1105 that is shown in FIG. 11 on the top of a bonnet nut 1102. When properly aligned, the pin can traverse all the way through the bonnet nut 1102 and into a plug alignment hole (not shown) in the plug 302. After the bonnet nut 1102 has been raised, the plug can be raised and reoriented. A spring pin can be inserted into the appropriate hole 1105 that is aligned with and corresponds with the desired outlet port that the plug is intended to align with during reorientation. The plug is reoriented by the reorienting mechanism which is a handle 310 in FIG. 3, the second end 344 of the fluid chamber 303 in the plug 302 is reoriented. As the plug 302 reorients, the plug alignment hole moves with it. When the second end 344 of the fluid chamber 303 in the plug 302 is aligned with the desired outlet port 320, the appropriate hole 1105 is then coaxial with the plug alignment hole so that the first spring pin housed in the hole 1105 can engage with the plug alignment hole. Once the first spring pin can be inserted into the plug alignment hole, the plug 302 is properly oriented with the desired outlet port. Then, the plug can be locked in place using the procedure discussed above.

A first seal 336, a second seal 337, and o-ring or other seal 338 encircle the plug 302 and are housed between the diverter body 301 to seal the plug 302 as fluid is directed to the desired output port. O-rings or other seals 362, 361, embedded in the plug 302, can be used to create a seal around each outlet port 320. First seal 336 and second seal 337 are radial seals that can be plastic energized seals. If a leak is detected, then by pressuring up with plastic packing through fluid ports 333, 335, a seal around the plug 302 can be created.

One or more stem o-rings or other seals 340 and one or more body o-rings or other seals 341 can be housed in the piston 311 and body 301 to assist in creating and maintaining a seal around the stem 307. While the described embodiment refers to the use of only one diverter, multiple diverters can be connected if desired.

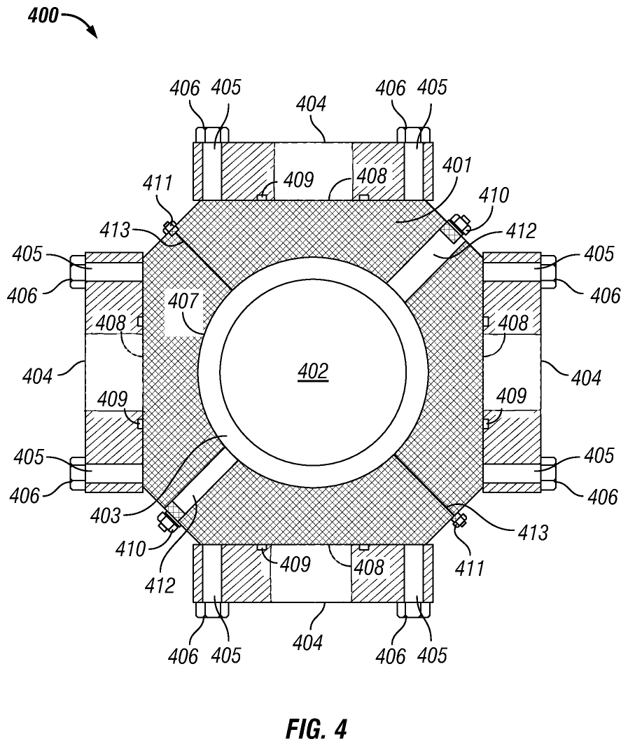

FIG. 4 is a cross-section top view of one embodiment of the diverter assembly 400. The top of the diverter body 401 includes an inlet port 407. Inside inlet port 407 is the plug 403, and the plug 403 and the center aperture 402 reside in the center of the inlet port 407. The center aperture 402 in the inlet port 407 is the aperture by which fluid can flow through the plug 403 housed in the diverter body 401. The diverter body 401 is illustrated as having an octagonal shape when viewed from the top; but other shapes known to one of ordinary skill in the art can also be used. Between each of the outlet ports 408 are fluid ports 410, 411. The fluid ports 410, 411 are located adjacent to medium channels 412, 413. There are two types of fluid ports displayed. The first one is a test fluid port 411, and the other is a wash fluid port 410. Each test fluid port 411 can be connected to a corresponding small channel 413. To test the seals, one of the test ports will be open while pressure is applied to the other. If pressure holds without escaping to the open port, then the seal is confirmed. Then, the other will be open and pressure up on to make sure that the seal is created. Similarly, the wash fluid port 410 can be connected to a large channel 412. One wash fluid port 410 will be opened and the other wash fluid port will have a fluid pressured through the diverter body 401. As the fluid moves through the diverter body 401, it flushes out residue such as sand that may be present in the diverter. Please note that in the displayed embodiment, the plug can be raised up ⅜ths of an inch when moving the washing fluid through the diverter body 401.

A handle (not displayed) can be used to reorient the plug 403 so that is aligned with one of the outlet ports 408. While not required, the diverter assembly 400 displayed in FIG. 4 can have flanges 404 adjacent to each outlet port 408. These flanges 404 are secured to the diverter body 401 by a flange stud 405 and a flange nut 406. The flanges 404 can be used to connect an outlet port 408 to a connector pipe (not shown). Between the flanges 404 and the diverter body 401 are o-rings or other seals 409 to maintain a sealed conduit for fluid to travel through. The displayed flanges 404 can be removed and replaced with flanges connected to pipe conduits that direct fluid to a desired wellbore. O-rings or other seals 409 encircle an outlet port (not shown) to create a seal between the diverter body 401 and flanges 404.

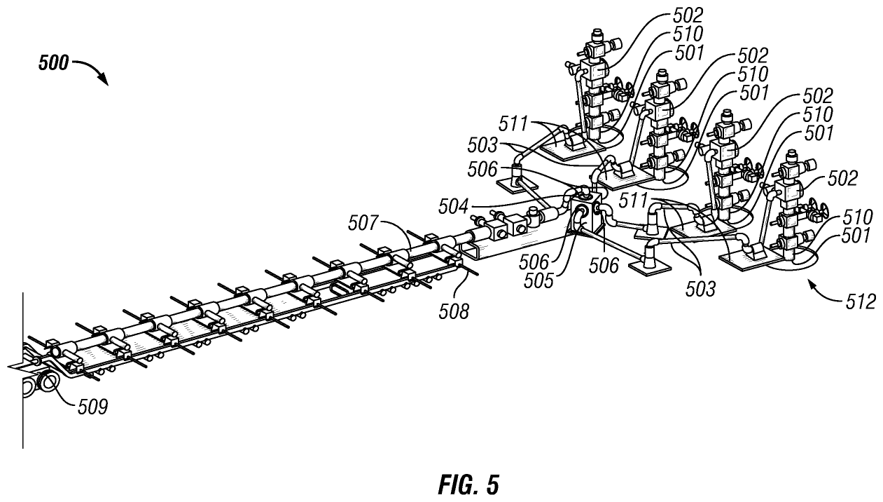

FIG. 5 is a perspective environmental view of one embodiment of the diverter 505 integrated into a fracturing system 500 assembled on a multi-well drilling pad. A portion of a high-pressure hydraulic fracturing diverter system 500 is displayed to illustrate one possible placement of a diverter. Four wells 501 are each connected to a wellhead 510 which, in turn, are connected to a Christmas tree 502. The Christmas trees 502 are each connected to a series of pipes 503 and plates 511 that can be secured to eliminate unnecessary movement in the diverter system 500. Fluid is directed through one of the connector pipes 503 into one of the Christmas trees 502 associated with a targeted well during a fracture stage. The diverter 505 is displayed as having four outlet ports 506 (two are shown). Each outlet port 506 is connected by a series of pipes 503 to a corresponding Christmas tree 502. An inlet port 504 on top of the diverter 505 allows fluid to travel from the fluid source—e.g., a missile 507—into the diverter 505. The missile 507 has various pump pipe connectors 508 that can be connected to high pressure pumps (not shown). Typically, these high-pressure pumps 508 are placed on the back of a truck 509 and are connected to the missile 507 via the pump pipe connectors 508.

As configured in FIG. 5, the diverter allows fluid to be directed to a single wellhead. All other wellheads 510 are blocked by the plug in the diverter and are sealed off from the missile 507 by the diverter. As a result, only the selected wellhead 510 that has a conduit through the diverter to the missile 507 can receive fracturing fluid. Once the fracture stage is complete, the plug in the diverter 505 can be reoriented to connect to a different outlet port 506 to designate a different well to receive fracturing fluid. The previously selected well is now available to have necessary maintenance or preparatory tasks for the next fracture stage performed. When the fracture stage is complete for the newly selected well, another well can be selected. This process can be continued for all the wells on a multi-well pad 512, alternating which well endures a fracture stage while other tasks are performed on the unconnected wells. This allows for downtime to be minimized and the necessary cost to fracture a well diminished. Using this method, no disassembly or reassembly is required to alternate between wells, reducing the number of personnel required for a hydraulic fracturing operation.

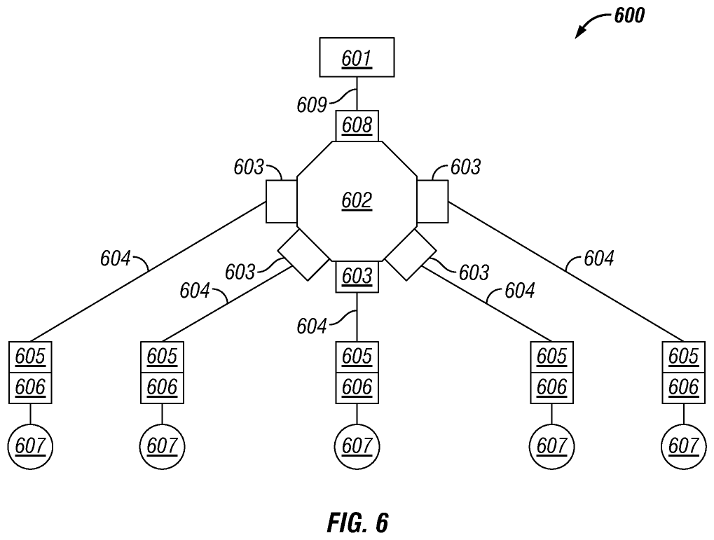

FIG. 6 is a schematic diagram of one embodiment of a diverter system 600. A fluid source 601 carries high-pressure fluid through a fluid source connector 609 to the inlet port 608 of the diverter body 602. The inlet port 608 which is connected to a plug (not shown) that allows for fluid to pass through the inlet port 608 into a fluid channel in the plug that is housed in the diverter body 602. Outlet ports 603 are coupled on multiple sides of the diverter body 602. In the disclosed embodiment, there are five outlet ports 603; however, the number of outlet ports 603 coupled to the diverter body 602 is not limited to five and can be any number, if there is at least one outlet port 603.

An outlet selector (not shown) is coupled to the diverter body 602 and used to select one of the outlet ports 603 to which the inlet port 608 is coupled. As a result, fluid that enters the inlet port 608 from the fluid source can pass through the diverter body 602 into one of the connected outlet ports 603. Only one of the connected outlet ports 603 can receive fluid. The other outlet ports 603 are sealed off and will not receive any fluid from the fluid source 601.

Each outlet port is coupled to a corresponding conduit connector 604. The conduit connector 604 is typically pipe (also called iron) that is used in the oil field and can handle fluids at high pressure. On the opposite side of each conduit connector 604 is a connected Christmas tree 605. Alternatively, the Christmas tree 605 can also be called a fracturing stack or fracturing tree. Each fracturing stack is then coupled to the corresponding wellhead 606 which, in turn, is coupled to a corresponding wellbore 607. The result is that fluid that passes through from the inlet port 608 is directed to the wellbore 607 that is in a direct path to the exclusively connected outlet port 603.

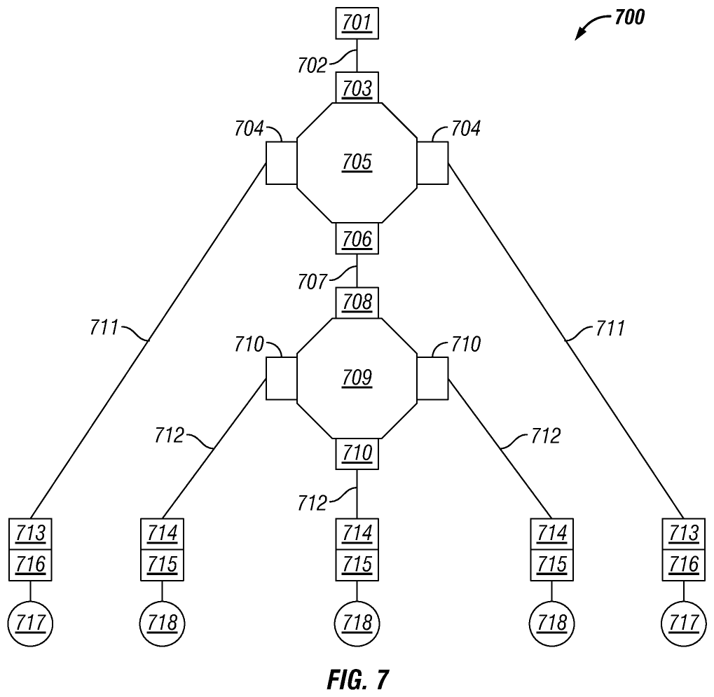

FIG. 7 is a schematic diagram of an alternate embodiment of the diverter system 700 that includes two diverters 705, 709 connected in series. The difference between the embodiment disclosed in FIG. 6 and the one disclosed in FIG. 7 is that the alternate embodiment in FIG. 7 has two diverter bodies connected in series, as opposed to a single diverter body. Note that the present invention is not limited to just two diverter bodies connected in series. Other alternate embodiments could include any number of diverters connected in series or parallel as desired for the application.

The fluid source 701 is connected to the first inlet port 703 of the of the plug that is housed in the first diverter body 705 via a fluid source connection 702. Various first outlet ports 704 associated with individual wells are coupled to the first diverter 705. An actuator that is coupled to an outlet selector on the first diverter body 705 allows for a specific first outlet port 704 to be selected and isolated so that fluid that travels from the fluid source 701 through the inlet port 703 and fluid channel housed in the plug, only pass to the selected first outlet port 704. All other first outlet ports 704 are sealed off and no fluid can pass through them. The first outlet ports 704 are then connected to a first fracturing stack 713 via a first pipe conduit 711. Then each fracturing stack 713 is connected with a wellhead 716 which is connected with a corresponding wellbore 717. Included with the first outlet ports 704 for selection to be connected to the fluid chamber is a series connector outlet port 706.

A series connector conduit 707 couples the series connector outlet port 706 to a second inlet port 708 that is a part of a second plug housed in the second diverter body 709. Thus, the first diverter 705 serves as the fluid source for the second diverter 709. Fluid that passes through the series connector outlet port 706 then travels into the second inlet port 708 onto a second fluid channel housed in the second plug. The second diverter 709 is like the first diverter 705, but the outlet ports 710 are all connected to individual well bores 718.

In the disclosed embodiment, there are only two diverters connected in series. However, a third, fourth, fifth, etc. diverter could be connected in series with the previous diverter to effectively expand the number of outlet ports available. Each selector mechanism can then be properly oriented to direct fluid to a specific well from a single original fracturing fluid source. This process of replacing an outlet port with a series connector outlet port linking two diverters together could continue for as long as is needed.

As with the first outlet ports 704, the second outlet ports 710 are connected to a corresponding Christmas tree 714 or fracturing stack via a second pipe conduit 712. Each Christmas tree 714 is then coupled to a corresponding wellhead 715 which is then coupled to a well bore 718. This allows for fluid that pass through a connected second outlet 710 to have a direct path to the wellbore 718 at the end of that connection. The result is that any of the wellbores 717, 718 can be selected to receive fluid from the fluid source. The connection can be made without further assembly or disassembly of the fracturing system.

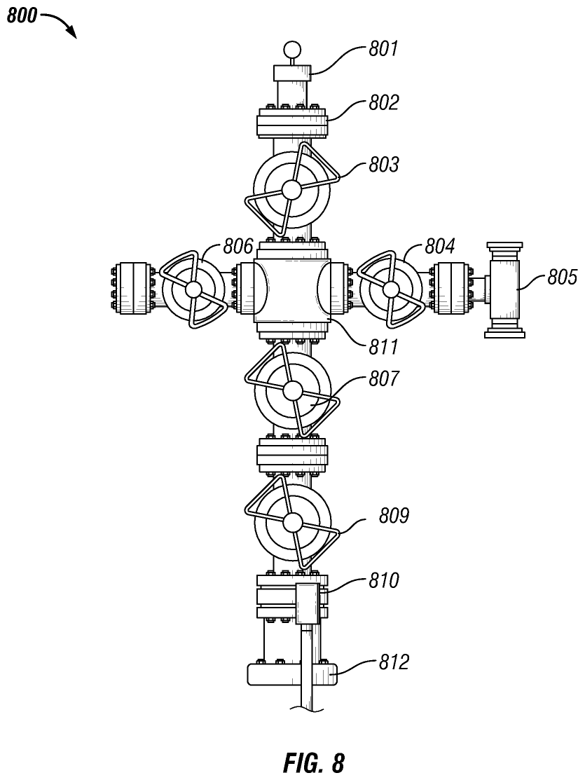

FIG. 8 is a side view of a Christmas tree 800 or fracturing stack that can be utilized with a diverter. A tree top adapter 802 with a tree cap 801 can be installed at the top of the Christmas tree 800. A top plug on the tree cap 801 can house a pressure gauge which can be utilized to measure well pressure. A swab valve 803 can be connected to the tree top adapter 802. The swab valve 803 is positioned so that it is in line with well intervention procedures such as wireline and coiled tubing. Often a second swab valve will be placed adjacent to the first swab valve 803 to serve as a second barrier. On the sides of the Christmas tree 800 are wing valves 804, 806. As shown in FIG. 8, the wing valve on the right side is the flowback valve 804. Through this valve, the flowback operations can be handled. During flowback operations, the medium coming up out of the wellbore is a mixture of crude oil, natural gas, water, and sand. Flow back operations typically involve the separating out the various types of medium after the well has completed a complete hydraulic fracturing operation. A surface choke 805 is typically installed in line with the flowback valve 804 to control the amount of fluid that passes therethrough. On the opposite side of the Christmas tree is the kill valve 806. The kill valve 806 is used to inject fluids into the well such as corrosion inhibitors or methanol to prevent hydrate formation.

Below the kill valve 806 and the flowback valve 805 are the master valves 807, 809. The swab valve 803, kill valve 805, and the flowback valve 804 are all connected to one of the master valves through a flow cross 811 that has four flanged connections. Each one of the master valves is positioned in the direct line into the wellbore. In this embodiment, there are two master valves, a top master valve 807 and a bottom master valve 809. Both valves can serve as a barrier to all fluid traveling through the Christmas tree 800. The bottom master valve 809 is then coupled to a tubing head adapter 810 that connects to the wellhead 812. Lastly, the wellhead 812 is coupled to the casing string that descends into the wellbore.

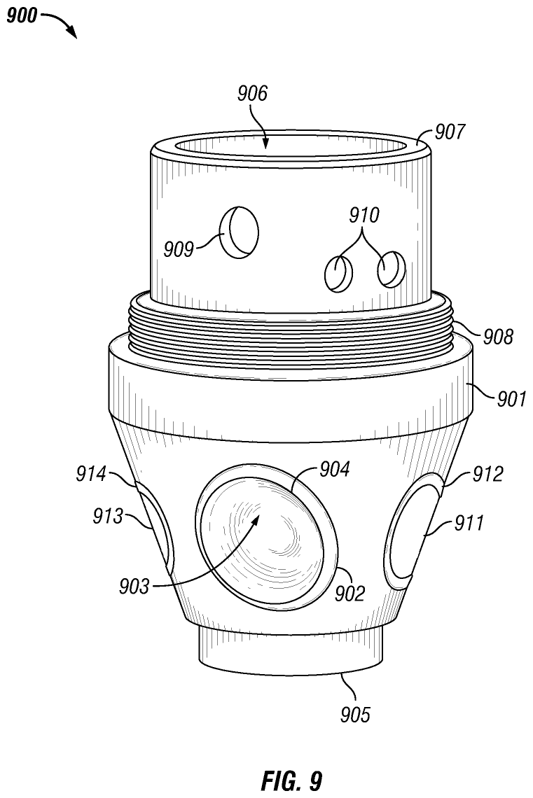

FIG. 9 is a perspective view of an embodiment of a plug 901 that can be utilized in a diverter. Such a plug 901 could be used with an alternate embodiment of the diverter which has an alternate means of coupling the bonnet nut to diverter body. The plug body 901 has an inlet port 907 through which fluid from a fluid source can flow through an inlet aperture 906. When the plug 901 is mated with a diverter body (not shown), the base 905 of the plug will interface with the diverter body. A threaded surface 908 is provided to allow a bonnet nut (not shown) to be secured to the plug. Alternatively, the bonnet nut can have external threads for mating with the diverter body. The threaded surface 908 that is present in the alternate embodiment displayed in FIG. 9 is different from the embodiments discussed in FIG. 3-7. Other embodiments do not have the threaded surface 908 for securing a bonnet nut to the plug body 901. Rather, the embodiments discussed in FIG. 3-7 can have threads at the interface between the diverter body and the bonnet nut. The bonnet nut in those embodiments is raised or lowered by turning the bonnet nut by a wheel handle (not shown) and traversing the threads at the body/bonnet nut interface to raise or lower the nut relative to the diverter body during a reorientation of the plug of the diverter.

A retainer hole 909 is an aperture that can be used to insert a segmented retaining ring housed in a plug groove and an inlet groove for securing a fluid connection to the plug. The mounting apertures 910 can also be used for inserting threaded mounting bolts to secure an inlet pipe to the plug 901. When connected, a fluid source will generally be a pipe that has a specialized end intended for connection to the diverter.

Once the fluid enters the plug 901, it passes into the plug body by way of a fluid chamber 903 that is connected to the inlet aperture 906. From there, the fluid is directed into the connection port 902. The connection port 902 has an outlet aperture 904 the allows for fluid to exit the plug 901. When the plug 901 has been inserted into a diverter body, the connection port 902 can be aligned and connected to one of potentially several outlet ports. The outlet ports, in turn, are connected to a connection pipe that directs the fluid to a selected wellbore. Only the outlet aperture 904 allows access to the fluid chamber inside the plug 901. Outlet sealing surfaces 911, 913 are not apertures and do not allow access to the fluid chamber inside the plug 901. Outlet sealing surfaces 911 and 913 are configured to cover and seal the unused outlet connections. The sealing surfaces 911, 913 are encircled by o-rings or other seals 912, 914 to provide a positive seal to the unused ports when the diverter is locked down as discussed below.

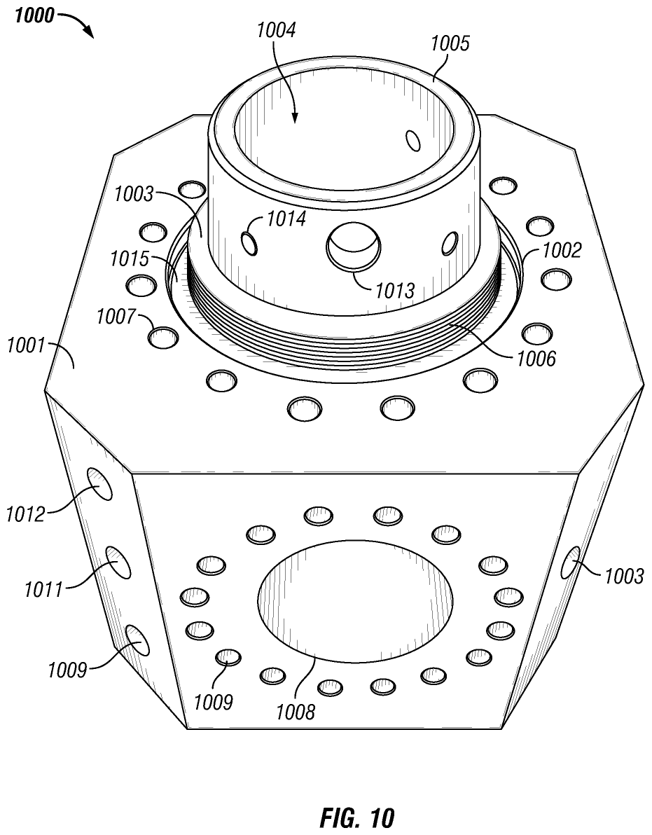

FIG. 10 is a perspective view of an embodiment of a diverter assembly 1000 with a plug 1003 in a diverter body 1001. As shown, the plug 1003, which could be the plug disclosed with reference to FIG. 9, is fully inserted into the diverter body 1001 through a diverter body aperture 1002. The shape of the internal cutout of the diverter body generally matches and mates to the external shape of the plug 1003. Once a fluid source is connected to the diverter at the first end 1005, fluid enters the diverter assembly 1000 through the inlet aperture 1004 and passes through a fluid chamber on its way to exiting the diverter body 1001 via an outlet aperture 1008 of the outlet port. The plug thread interface 1006 is exposed so that a bonnet nut can be joined with or threaded onto the plug 1003 to be interfaced along a plug/bonnet interface 1015, and a set of inlet pipe mount holes 1007 encircle the first end 1005 of the plug 1003 so that an inlet pipe can be properly secured to the diverter body 1001 with a set of bolts. The alternate embodiment of the plug 1003 has the plug threaded interface 1006 as displayed in FIG. 10. Other embodiments have a threaded interface located along the bonnet/body interface to allow for the bonnet nut to be coupled to the diverter body 1001. A set of outlet pipe mounting holes 1009 are present to allow a set of bolts to secure an outlet pipe with an outlet flange to the diverter body 1001. Additionally, several plug/gland fluid ports 1009, 1011, 1012, 1013 are present on the outer surface of the diverter body 1001 to allow for media such as energizing fluid or wash fluid to be applied in a fluid channel so that pressure can be communicated to the plug 1005 while it is housed inside the diverter body 1001. A retainer hole 1013 is present to allow for the segmented retainer ring to be inserted therethrough, and mounting holes 1014 are present to allow for threaded mounting bolts to secure the plug 1003 to an inlet pipe.

FIG. 11 is a top view of a diverter assembly 1100. The diverter body 1108 is situated so that an inlet joint 1101 can be coupled to the plug 1104 housed in the diverter body 1108. Even though the inlet joint 1101 has been secured to the plug 1104 while the plug 1104 has been housed in the diverter body 1108, a portion of the plug 1104 is still visible. Four outlet ports (not shown) are located on each side of the diverter body 1108. Encircled around each of the outlet ports is a set of studs 1103 that are used to attach a connection pipe to an outlet port. There are also body holes 1106 that allow for other types of inlet pipes to be connected to the diverter body 1108.

The diverter body 1108 has a bonnet nut aperture 1107 that houses a bonnet nut 1102. When the plug 1104 is in the process of being sealed, the bonnet nut 1102 is turned until it presses against the plug 1104 along a plug/bonnet interface (not shown), for locking the plug 1104 down. When the plug 1104 is in the process of being reoriented, a plug/gland fluid port will be used to pressure down on the plug 1104 to relieve some pressure between the plug and bonnet nut 1102. A hand wheel (not shown) or spanner wrench that is attached to the bonnet nut 1102 with a stud inserted into two of the bonnet holes 1105 is then used to rotate and loosen the bonnet nut 1102. As the hand wheel turns the bonnet nut 1102, the bonnet nut 1102 rises which, in turn, provides space for the plug 1104 to rise as well when pressure is applied to a plug/gland fluid port used for raising the plug 1104. After the plug 1104 has been reoriented and connected to a different connection port that directs fluid into a different outlet port, a different plug/gland fluid port is used to push the plug 1104 down. Once the plug 1104 has been pushed down, the bonnet nut 1102 is then turned to tighten, causing it to press down into the bonnet nut aperture 1107 until the bonnet nut 1102 bottoms out on the plug 1104 along a bonnet/plug interface, locking it in place. At this point, the pressure in the plug/gland fluid port can be released and the plug 1140 is sealed allowing fluid to be directed exclusively into the desired outlet port.

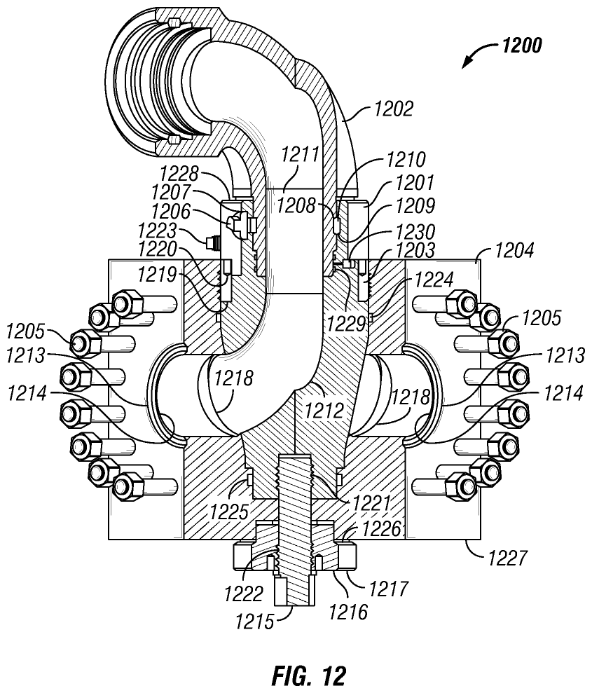

FIG. 12 is an assembly section view of a diverter assembly 1200. The plug 1201 is shown coupled to one of the connection ports 1218 and an outlet port 1213 on the left side of the figure. Encircling each outlet aperture 1214 is a set of studs 1205. The studs 1205 can be used to secure a flange for connecting a connection pipe to the diverter body 1204. An inlet joint 1202 is inserted through a plug aperture 1228 and coupled to the plug 1201 that resides in the diverter body 1204. Housed in a plug groove 1209 is a segmented ring 1210. The segmented ring 1210 has several segments of metal that span the circumference of the segmented ring groove 1209. The segmented ring 1210 can have a cross-sectional hexagon shape or any other shape desired. In the present embodiment, the segmented ring 1210 is made of a stainless steel. The outer perimeter of the segmented ring 1210 is housed in an inlet groove 1208 such that the segmented ring 1210 is housed between the inlet groove 1208 and the plug groove 1209. Both the plug groove 1209 and the inlet groove 1208 can have an isosceles trapezoidal shape so that the segmented ring 1210 is subject to a compression force, rather than a shear force when pressure is applied to the system.

When the diverter 1200 has fluid under pressure traversing through it, the pressure causes the inlet joint 1202 to be pushed away from the plug 1201. As this occurs, the ring 1210 retains the connection between the plug 1201 and the inlet joint 1202.

Further detail on how a segmented ring 1210 can be installed is now provided. After the inlet joint 1202 has been inserted into the plug 1201, a retainer plug 1206 is removed from a retainer hole 1207 that is located along the outer surface of the inlet joint 1202. The retainer hole 1207 is sufficiently large to allow a segment of the segmented ring 1210 to be inserted. In one embodiment, these segments are approximately 0.8223 inches tall by 1.93 inches wide and 1.467 inches thick. However, one with skill will understand that the segment rings can be sized differently as needed for a particular application and pressure requirement. The individual segments of the segmented ring 1210 are inserted one by one and pushed through the retainer hole 1207 until the segments wrap all the way around the plug groove 1209. The retainer hole 1207 is located on the inlet joint 1202 so that when it is exposed, the plug groove 1209 is exposed. Then, the individual segments of the segmented ring 1210 are inserted through the retainer hole 1207 to be housed in the plug groove 1209. Once all the segments have been inserted and the segmented ring 1210 is formed, the retainer plug 1206 is reinserted into the retainer hole 1207. Thus, the segmented ring 1210 maintains the inlet joint 1202 connection to the plug 1201 when pressure is applied.

Near the retainer hole 1207 is a mounting hole that allows for a threaded mounting stud 1223 to be used to further secure the inlet joint 1202 to the plug 1201. The fluid passes from the inlet chamber 1211 into the plug chamber 1212 directing it into the desired outlet port 1213. An o-ring or other seal 1229, along with an inlet plug/gland fluid port 1230, are located on the inlet joint 1202 closer to the base of the plug 1201 than the inlet groove 1208, and can be used to create a seal between the plug 1201 and the inlet joint 1202.

To seal the plug 1201 in the diverter body 1204, an energizing fluid is applied to a fluid channel near the diverter body base 1227 to communicate pressure to the piston 1216. The pressure pushes the piston 1216 away from the diverter body 1204. At a stem piston interface 1221 the piston 1216 is coupled to the stem 1215 using threads. This pressure in turn puts pressure on the stem 1215 which pushes the stem 1215 downward. This creates a gap between the diverter body base 1227 and a lock ring 1217. The lock ring 1217 is turned until the gap between the locking ring surface 1226 and the diverter body base 1227 is eliminated. Then, a bonnet nut 1203 is turned with a wheel handle (not shown) so that the bonnet nut 1203 that is joined or threaded into to diverter body 1204 moves downward until it engages with the plug 1201 along a plug/bonnet interface 1219. The plug 1201 is locked in place by the lock ring 1217 from the bottom and the bonnet nut 1203 from the top. Once locked, the pressure in the pressured-up plug/gland fluid port is released, and the plug 1201 will remain locked in the sealed position. As a result, the seals around the outlet ports 1218 are maintained.

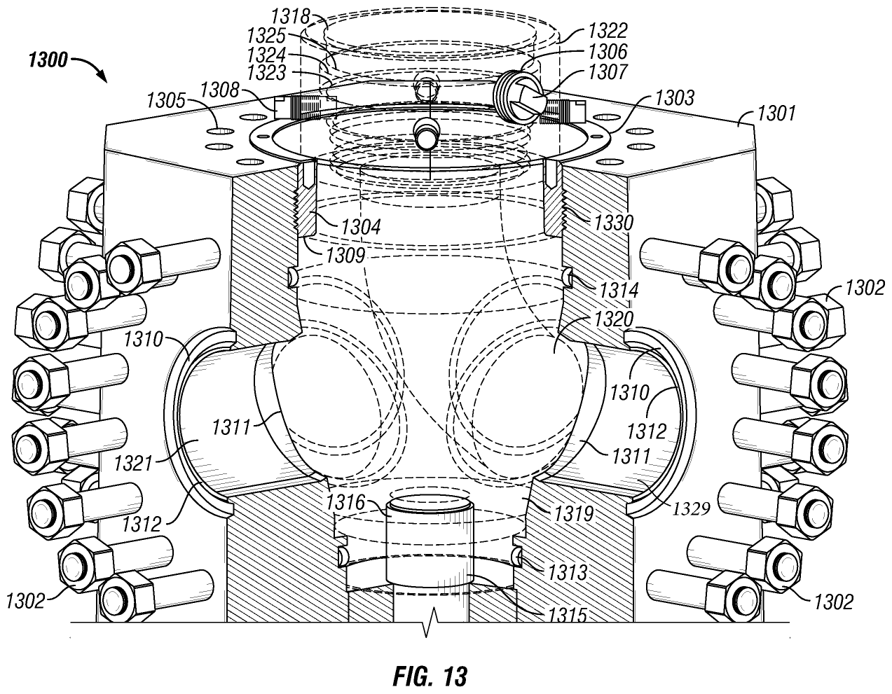

FIG. 13 is an assembly section perspective view of a diverter assembly 1300 showing plug orientation. The diverter 1301 has multiple outlet ports 1321 and each have an outlet aperture 1312. Each outlet aperture 1312 is encircled by a set of studs 1302 that can be used to secure another pipe through a flange to the diverter body 1301. Each one also has an outlet groove 1310 that can hold an outlet o-ring or other type of seal (not shown) to create a seal. The plug 1319 is positioned inside the diverter body 1301 such that it is capable of being sealed against the diverter body 1301. When sealed in an appropriate orientation, fluid leaving an inlet fluid chamber 1318 of the inlet pipe 1322 is directed through the plug fluid chamber 1320 into the desired outlet port 1329.

By unlocking the lock ring and bonnet nut and applying pressure through a fluid port to lift the plug 1319 as discussed above, the plug 1319 can be reoriented so that it is connected to a different connection port 1311 on a different outlet port 1329. Upon reorienting the plug 1319, fluid is directed to a different wellhead that is connected to the newly connected outlet port 1329. The previously connected outlet port 1321 is sealed off by a sealing surface, and fluid is no longer allowed to pass through it to the previously selected wellhead. After the plug 1319 has been reoriented, pressure is administered to the designated fluid port used to seal the plug 1319. Please note that in the present embodiment, the fluid port used to lift the plug 1329 for reorientation is a different fluid port than the one used to pull the plug 1329 down. After pressuring up, the bonnet nut 1304 that interfaces with the plug 1319 along a plug/bonnet interface 1309 can be turned by a hand wheel (not shown) that is coupled to the bonnet nut 1304 by a stud inserted into hole on the bonnet nut until it bottoms out on the plug 1319. The lock ring can also be tightened up to eliminate the gap between the lock ring and the diverter base 1301.

As the bonnet nut 1304 is turned, it rises out of the bonnet nut aperture 1303. In turn, the plug 1319 is not being inhibited can be raised as well by applying pressure. When the plug 1319 has risen around ⅜ths of an inch, the plug 1319 can now be reoriented. A stem 1315 is turned at the base of the diverter body 1301. By a set of threads along the stem/plug interface 1316, the plug 1319 is turned as well. The fluid chamber is disconnected from the previously connected connection port 1311 and continues to rotate with the entire plug 1319 until it is connected with a new connection port 1311. By utilizing this method, the first seal 1313 and the second seal 1314 are not cut in the reorientation process. Body mounting holes 1305 are present on the surface of the diverter body 1301 to assist with the connection to an inlet flange if needed.

Now that the plug 1319 has been reoriented, a plug/gland fluid port will be pressured up so that the plug 1319 is pulled downward and a gap is created between a lock ring and the base of the diverter body 1301. The lock ring can be tightened to eliminate the gap. Then, the bonnet nut 1304 can be turned by the hand wheel, lowering the bonnet nut 1304 into the bonnet nut aperture 1303. The bonnet nut 1304 is lowered until it bottoms out against the plug 1319 at the plug/bonnet interface 1309. Pressure at the plug/gland fluid port is released, but the plug 1319 is held in place and sealed against the diverter body 1301 by the lock ring and the bonnet nut.

The inlet pipe 1322 is connected to the plug 1319, and a segmented ring 1323 has been inserted through a retainer hole 1306 and housed between the inlet groove 1324 and the plug groove 1325. A retainer plug 1307 is inserted into the retainer hole 1306 to seal it off and to hold the segmented ring 1323 in place. Threaded mounting studs 1308 are used to secure the inlet pipe 1322 to the plug 1319.

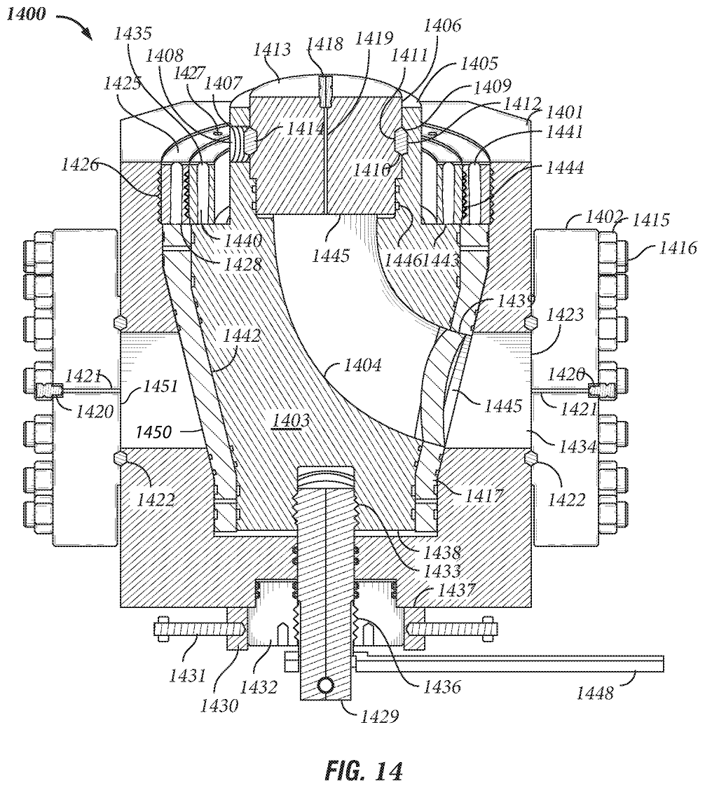

FIG. 14 is a side cross-section view of an alternate embodiment of a diverter assembly 1400. The diverter assembly 1400 has a plug 1403 in a sleeve 1417 that is housed in a diverter body 1401. An inlet joint 1413 can be inserted through an inlet aperture 1406 into the first end 1405 of the plug 1403 so that an inlet end 1445 is in-line with the fluid chamber 1404 in the plug 1403. The inlet joint 1413 is inserted past the one o-rings or other type of seal 1446, which is present near the inlet end and traverse the outer circumference of the inlet joint. In the displayed embodiment, there are two o-rings or other types of seals that the inlet joint is inserted past. There can be more than one, but in one embodiment there should be at least one o-ring or other seal 1446.

Housed at the first end 1405 of the plug 1403 in a plug groove 1412 and in an inlet groove 1411 of the inlet joint 1413 is the segmented ring 1414. The segmented ring 1414 can consist of eighteen (18) stainless steel metal segments that are configured to form a ring when placed adjacent to each other. The cross-section of the segmented ring 1414 is in a hexagon shape. Accordingly, the plug groove 1412 and the inlet groove 1411 have an isosceles trapezoidal shape that matches the hexagon shape of the segmented ring 1414. The purpose of the segmented ring 1414 is to keep the inlet joint 1413 connected to the plug 1403. The benefit of the using the segmented ring 1414 is that its configuration puts the segmented ring 1414 under compression instead of subjecting it to a shear force. Compression is accomplished by having an inlet compression surface 1410 in the inlet groove 1411 press against the segmented ring 1414. This, in turn, causes the segmented ring 1414 to press against the plug groove 1412. The inlet groove 1411 must be configured so that a perpendicular line emanating from the center of the inlet compression surface 1410 travels across the segmented ring 1414 and crosses somewhere along the plug compression surface 1409 of the plug groove 1412. If the perpendicular line that starts from the center of the inlet compression surface 1410 does not cross anywhere along the plug compression surface 1409 then the segmented ring 1414 will not be under compression, it will endure a shear force.

After the inlet joint has been inserted into the plug 1403, individual segments of the segmented ring 1414 can be inserted through a retainer hole 1407 into the space between the inlet joint 1413 and the plug 1403. Once all the segments of the segmented ring 1414 have been inserted, a retainer plug (not shown) can be inserted into the retainer hole 1407 and secured by engaging a retainer thread interface 1408 that lines the retainer hole 1407.

Near the base of the diverter body 1401, a stem engages with the plug 1403 along a plug/stem interface 1438. The stem 1429 can also be coupled by threads with a piston 1432 along a stem/piston interface 1436. A lock ring 1430 can be coupled to the piston 1432 and it can be tightened or loosened by a set of bolts 1431.

In the displayed alternate embodiment, the sleeve 1417 is an isolation sleeve. It can be made of the same material that the plug 1403 is made of such as a stainless alloy steel. When assembling the diverter 1400, the sleeve 1419 can be inserted first, before the plug 1403 is inserted. The sleeve 1417 can move with the plug 1403 when the plug 1403 endures pressure to seal or reorient the plug 1403; however, it can also be moved independent of the plug 1403. The sleeve 1417 has three open ports 1445 that correspond to the location of three of the outlet ports 1434. However, there is no outlet at the location of fourth outlet port 1450, allowing one of the outlet ports 1434 to be closed off as needed by reorienting the sleeve 1417 and allowing the plug 1403 to then move independently of the sleeve 1417.

In normal operation, as the plug 1403 is reoriented to be aligned with a new outlet port 1434, the sleeve 1417 will move with the plug 1403 and will always allow fluid through whatever outlet port 1434 the plug 1403 is aligned with. However, if there is an issue with a particular well that needs to be closed for safety or other reasons while the diverter is allowed to serviced other wells, then the sleeve 1417 can be positioned so that the closed portion of the sleeve 1450 covers the outlet port 1434 associated with that well and the sleeve 1417 is then fixed in place relative to the diverter body, allowing the plug 1403 to be moved independently of the sleeve 1417. In this configuration, the plug 1403 can then only direct fluid to one of the three other outlet ports 1434.

A plug retention nut 1440 in FIG. 14 acts similarly to the bonnet nut 329 in FIG. 3. A plug retention handle (not shown) or spanner wrench can be coupled to the plug retention nut 1440 by securing it using one or more of a plurality of holes 1435 located around the top of the plug retention nut 1440. Each hole 1435 of the set of plug retention holes can also be used for alignment purposes. A plug alignment spring pin (not shown) can be inserted through one of the holes 1435 and traverse all of the way through the plug retention nut 1440 to engage with an alignment hole (not shown) in the plug 1403. The alignment holes can be positioned in line with each of the outlet ports to allow positive alignment of the plug outlet 1403 with an outlet port.

If the plug alignment spring pin is not engaged with a plug alignment hole, the plug can be oriented by turning an orientation handle 1448 without moving the plug retention nut 1440. The plug retention handle can be turned which can cause the plug retention nut 1440 to engage with threads on the sleeve retention nut 1425 along a plug retention nut interface 1444. The plug retention nut 1440 can move with or independent of the sleeve retention nut 1425. By turning the plug retention handle, the plug retention nut 1440 can engage with the matching threads on the sleeve retention nut 1425 along the plug retention nut interface 1444 and both will either rise or descend together unless the sleeve retention nut 1425 is being held in place.

The sleeve retention nut 1425 can be held in place by at least two methods. A sleeve retention handle (not shown) or spanner wrench can be coupled to the sleeve retention nut by one or more studs inserted into a one or more of a plurality of holes 1441 around the top of the sleeve retention nut 1425. The user can then secure the sleeve retention handle, not allowing it to move while turning the plug retention nut 1440. Thus, the plug retention nut 1440 will either rise or descend while the sleeve retention nut 1425 does not move.

The sleeve retention nut 1425 can be secured to the sleeve 1417 in the same manner that the plug retention nut 1440 can be secured to the plug 1403. A sleeve alignment spring pin (not shown) can be inserted into a sleeve retention hole 1441 through the sleeve retention nut 1427 to engage in one of a plurality of sleeve alignment holes (not shown). This will secure the sleeve retention nut 1425 to the sleeve 1417. When the spring pin is engaged, the sleeve 1417 and the sleeve retention nut 1425 will move together.

If the closed portion of the sleeve 1450 is positioned adjacent to an outlet port 1434 so that fluid is inhibited from passing through the outlet port 1434 and the closed portion 1450 is under pressure, the sleeve retention nut 1425 may be inhibited from moving with the plug retention nut 1440 even if the sleeve retention handle is not secured. An example of pressure being applied to the closed portion 1450 can include flowback pressure from an in-line well. The sleeve retention nut 1425 will be prohibited from moving as well if the sleeve alignment spring pin has been inserted into one of the holes 1441 and engaged with an alignment hole in the sleeve 1417. If the sleeve alignment spring pin has not been engaged, then the sleeve retention nut 1425 can be moved together with the plug retention nut 1440.

To reorient the plug 1403, the plug retention nut 1440 can be turned to raise the plug retention nut 1440 relative to the diverter body 1401. Once a gap of approximately ⅜ths of an inch is created at the plug/nut interface 1443, a fluid port designated to lift the plug 1403 is pressured up to raise plug 1403. The orientation handle 1448 can be turned to align the fluid chamber 1404 with the desired outlet port 1434. If the sleeve retention nut 1425 is not prohibited from moving during the reorientation process, the sleeve retention nut 1425 can move with the plug retention nut 1440. Similarly, the sleeve 1417 will rise and descend along with the plug 1403 as corresponding fluid ports are pressured up to raise or lower the plug/sleeve combination. However, if the sleeve retention nut 1425 remains locked in place or the sleeve 1417 is enduring a force that prohibits it from moving, then the sleeve will stay in place while the plug 1403 is being reoriented.

In the embodiment disclosed in FIG. 14, to detect when the plug 1403 has been correctly aligned with the correct outlet port 1434, the plug alignment spring pin can be inserted into the appropriate hole 1435 on the top of the plug retention nut 1440. When properly aligned, the plug retention spring pin can traverse through the plug retention nut 1440 to engage with a plug alignment hole in the plug 1403.

Before the plug is reoriented, the plug retention spring pin can be removed from the current plug retention hole 1435 that it is housed in and placed in a different plug retention hole 1435 that corresponds with the new outlet port 1434 that is to be targeted. As the plug 1403 is reoriented, the plug alignment hole moves along with the plug 1403 until the plug retention spring pin again engages with the plug alignment hole, indicating alignment with the new outlet port 1434. The plug 1403 can be locked into place using the procedure discussed above. Once the plug has been sealed, the desired outlet port 1434 has been selected for receiving fluid and the previous outlet port 1434 has been excluded from receiving fluid. If the sleeve 1407 is allowed to move with the plug 1403, then the sleeve 1417 will be oriented in line with the desired outlet port 1434 as well.

In an alternate embodiment, the sleeve retention spring pin can be removed from a sleeve retention hole 1441 that corresponded with the previously selected outlet port 1434 and inserted into a new sleeve retention hole 1441 that corresponds with the desired outlet port 1434. The sleeve retention nut can move in coordination with the plug retention nut 1440 until the sleeve alignment hole is coaxial with the sleeve retention hole 1441 which allows for the inserted sleeve spring pin to engage with the sleeve alignment hole, aligning the sleeve 1417 and plug 1403 with the desired outlet port 1434.

When the appropriate fluid port in the diverter body 1401 is pressured up applying pressure to piston 1432, the plug 1403 is pulled down by the stem 1429. If the sleeve 1417 was also raised, the plug 1403 will pull the sleeve 1417 down as well. This creates a gap between the piston 1432 and the diverter body 1401 along the body/piston interface 1437. Then, the plug retention nut 1440 is reoriented by turning a plug retention handle (not shown). The plug retention nut 1440 is turned which engages the threads along the plug retention nut interface 1444 until the plug retention nut 1440 bottoms out on the plug 1403 along the plug/nut interface 1443. Likewise, if the sleeve 1417 was in the raised position, the sleeve retention nut 1425 can be turned down simultaneously with the plug retention nut 1440. Although, not required, the locking ring 1430 can be tightened by turning the set of bolts 1431 to eliminate the gap between the lock ring 1430 and the diverter body 1401. Pressure can then be released on the designated fluid port and the plug 1403 and sleeve 1417 is now sealed in the diverter body 1401.

Around the exterior and on opposite sides of the diverter 1400 from each other are test fluid ports 1420 which are connected to test fluid channels 1421. The test fluid ports 1420 and test fluid channels 1421 are used to pressure test to make sure that a seal has been created around the desired outlet port 1434. A test cover 1402 is displayed in FIG. 14 adjacent to each outlet port 1434. These test covers 1402 can be secured to the diverter body 1401 by a bolt and a nut. These test covers 1402 are used to test the diverter 1400 and can be replaced with flanges to connect a conduit so that is aligned with the adjacent outlet port 1434 so that fluid can travel between them. An o-ring or other seal 1422 encircles the exit aperture 1423 of each outlet port 1434 and is housed between the test cover 1402 or flange and the diverter body 1401 to create a seal.

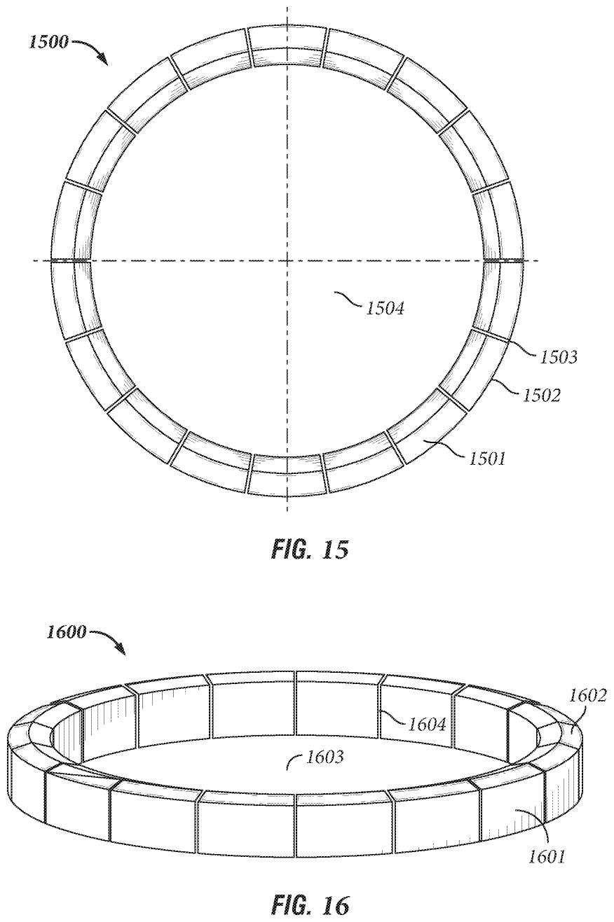

FIG. 15 is a top view of one embodiment of a segmented ring. The segmented ring 1500 can be used as a means of providing a connection between an inlet pipe and the diverter assembly as shown, for example, in FIG. 3 at ring 360 and FIG. 14 at ring 1414. The individual segments of the segmented ring 1500 are placed end-to-end to each other along an interface 1503 to form a ring around a center aperture 1504. Each one of the segments 1502 of the segmented ring has a hexagon cross-section shape. This shape allows for a compression surface 1501 on the segmented ring 1500 to experience compression and increase the amount of pressure the segmented ring 1502 compared to the pressure it could handle if it was enduring a shear force.

FIG. 16 is a perspective view of the segmented ring of FIG. 15. The segmented ring 1601 has multiple individual segments placed end-to-end to form a ring around a center aperture 1603. Each individual segment has a cross-section shape of a hexagon. The segments are placed adjacent to each other along an interface 1604. The segmented ring can have a variety of different dimensions. One embodiment of the segmented ring utilized in a diverter assembly connection as disclosed herein can have 18 individual segments that are used to assemble the segmented ring. These segments can be approximately 0.8223 inches tall by 1.93 inches wide and 1.467 inches thick. However, one with skill will understand that the segment rings can be sized differently as needed for a particular application and pressure requirement.

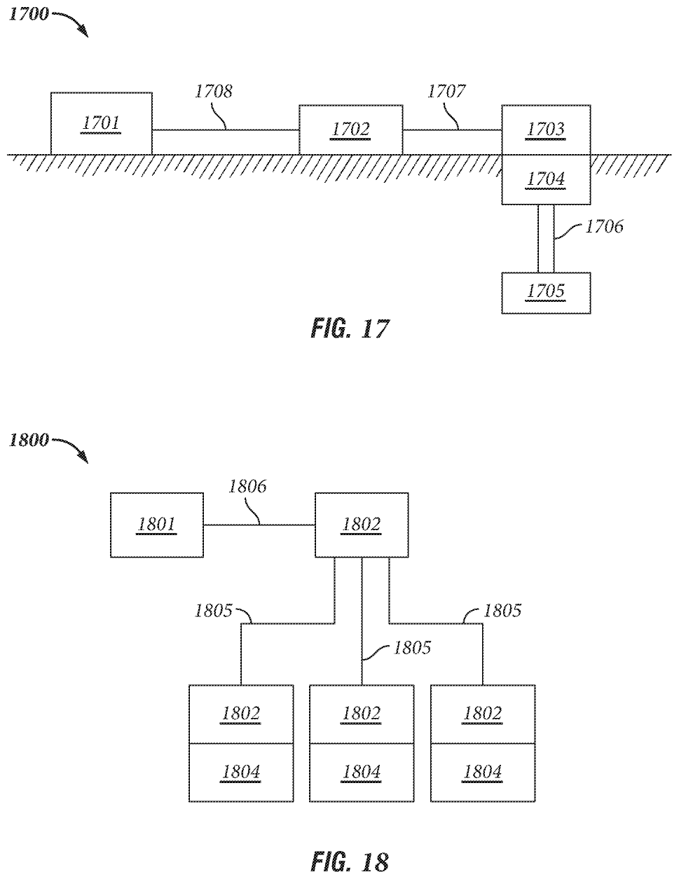

FIG. 17 is a schematic diagram of one embodiment of a diverter system 1700. The diverter 1702 of the diverter system 1700 can be located on the surface near a fracturing tree 1703 and connected to a fluid source 1701 by a first conduit 1708. The fracturing tree 1703 can be coupled to the diverter 1702 through a second conduit 1707 that can be similar to the fracturing tree 800 that is illustrated in FIG. 8; however, the fracturing tree is not limited to the style or configuration of elements disclosed in FIG. 8. The elements that can comprise a fracturing tree vary depending on the needs at the well site. So, any elements or pieces of a fracturing tree known to one of ordinary can be included or excluded according to the needs of the user. Any configuration of a fracturing tree known by one of ordinary skill in the art could also be utilized in the embodiment disclosed in FIG. 17. The fracturing tree can be coupled to a wellhead that provides access through a wellbore to a reservoir of subsurface material or minerals such as hydrocarbons.

FIG. 18 is a schematic diagram of one embodiment of a diverter system 1800 connected to multiple fracturing trees. In the diverter system 1800, a fluid source 1801 can be connected to the diverter 1802 through a first conduit 1806. Then, the diverter 1802 can direct a media into any one of the connected second set of conduits 1805 that are coupled to a specific fracturing tree 1803 or Christmas tree. All of the second set of conduits 1805 that are not the intended recipient of the media from the diverter 1802 can be excluded so that media only travels from the diverter 1802 to the intended fracturing tree 1803 and then into the desired wellhead 1804.

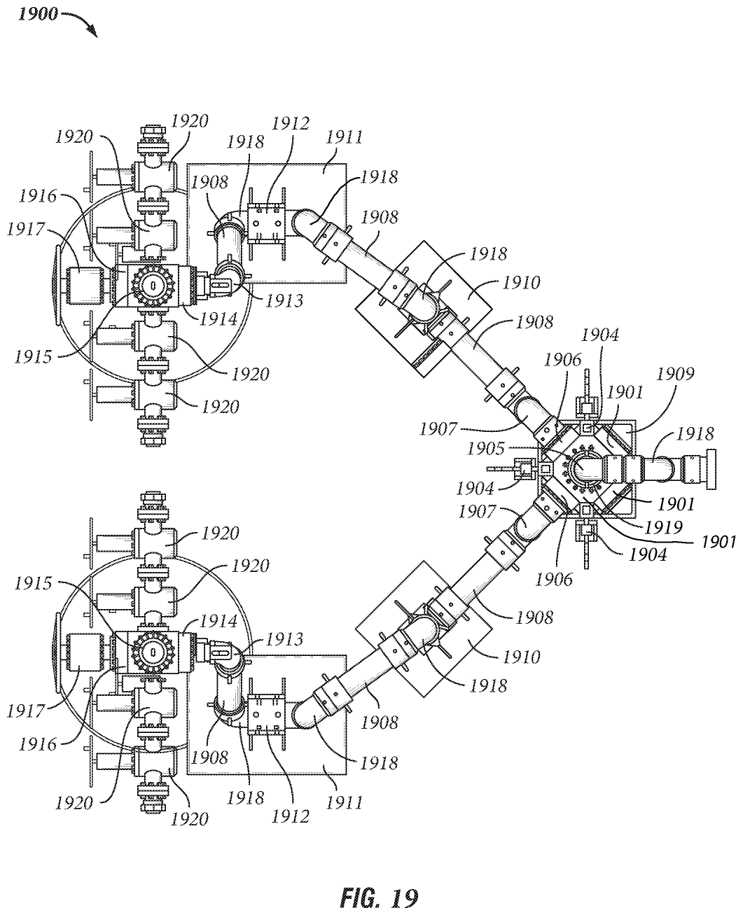

FIG. 19 is a top view of a diverter system 1900 connected to two fracturing trees. A diverter body 1902 can be incorporated into a diverter system 1900 that is coupled to an inlet joint 1905. Inlet joint 1905 is connected to various conduits—e.g., elbow joint 1918—that allow for fluid to travel from a fluid source (not shown) to the diverter body 1902. The fluid can contain small particulates such as proppant that are typically used in hydraulic fracturing cycles. The diverter body 1902 can be positioned on a diverter base 1909 that can be raised or lowered by at least one lifting mechanism 1904. The diverter body 1902 can have four outlet ports. However, in this embodiment, only two of the outlet ports are coupled to outlet flanges 1906 that connect to outlet joints 1907, allowing fluid to travel from the diverter body 1902 to a desired fracturing tree. The other two outlet ports are covered by a cover flange 1901 that can seal the outlet port so that fluid cannot pass therethrough.

Inside the diverter body 1902 there is a plug (not shown) that can be oriented by a selector mechanism (not shown) such as a handle or an actuator. The plug can divert fluid to a specific fracturing tree and inhibit fluid from traveling into non-desired fracturing trees. Once a specific outlet port that corresponds with the desired fracturing tree has been selected, fluid can pass through a string of connected conduits such as elbow joints 1918 and straight conduits 1908. To provide stability, the string of conduits can be coupled to a base 1910, 1911 that is positioned on the surface. The size of the base used can vary. In the displayed embodiment, there are two sizes, a small base 1910 and a large base 1911. The conduits can be secured to the bases with a mounting brace 1912 that can provide stability during hydraulic fracturing operations in which fluid at very high pressure is traveling through the conduits.

The conduits can be connected to the fracturing tree or Christmas tree through a fracturing tree connector joint 1913 that is coupled to the fracturing tree by a fracturing tree connector flange 1914. A fracturing tree can have various configurations that allow for multiple operations to be performed on the well such as adjust oil and gas well flow, monitor well pressure, and prevent hazardous liquids and gases from being released. The displayed configuration of the fracturing tree in FIG. 19 has a swab valve 1915 on top which is connected to several fracture valves 1920 via a cross 1916; and the cross 1916 sits on top of at least one master valve 1917 which controls access to the wellhead above the wellbore.

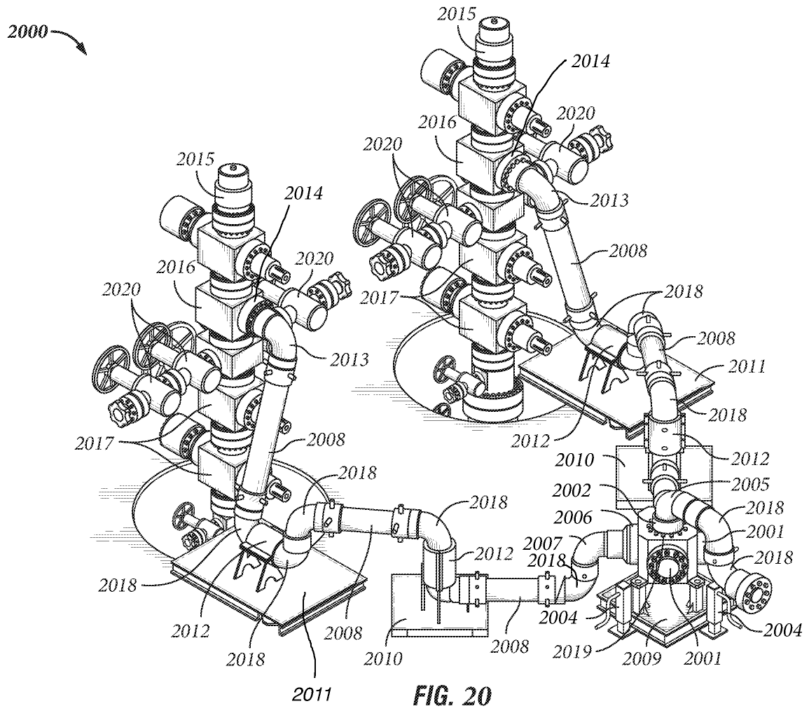

FIG. 20 is a perspective view of a diverter system 2000 connected to two fracturing trees. In the diverter fracturing system 2000, a fracturing tree or Christmas tree can provide access to a wellbore (not shown) through a coupled wellhead. The fracturing tree can have multiple configurations depending on the needs of the user. The displayed embodiment in FIG. 20 has two master valves 2017 coupled together on the bottom of the fracturing tree. A cross can be coupled on top that has multiple fracturing valves 2020 coupled together on the wings of the fracturing valve. On top, a swab valve 2015 can be coupled to the top portion of the cross. Fluid can access the fracturing tree through a flow cross 2016 by a fracturing tree connector joint 2013 connected to the flow cross 2016 by a fracturing tree connector flange 2014.

The fracturing tree connector joint 2013 is in line with a string of elbow joints 2018 and straight conduits 2008. Various elements of the string can be coupled to either a large conduit base 2011 or small conduit base 2010 with a conduit brace 2012. In the displayed embodiment, there are two strings that are coupled to the diverter 2002 through outlet joints 2007 coupled to outlet flanges 2006. When a selector mechanism is used to direct fluid into a specific wellbore, a plug internal to the diverter 2002 can be oriented to exclude all other outlet ports from access to fluid from a fluid source. The fluid travels from the fluid source, into an inlet string that can comprise elbow joints 2018, and into an inlet joint 2005 that couples to the diverter 2002. The diverter 2002 has two of its outlet ports covered by closed covers 2001. Even if the corresponding outlet port is selected with the plug, fluid will not be allowed to travel out of the diverter 2002. When selecting which outlet port to connect with, a bonnet nut 2019 can rise. Once the desired outlet port is selected, the bonnet nut 2019 can be inserted back into the diverter. If the diverter needs to be raised or lowered, then lifting mechanisms 2004 can be used to adjust the height of the diverter 2002.

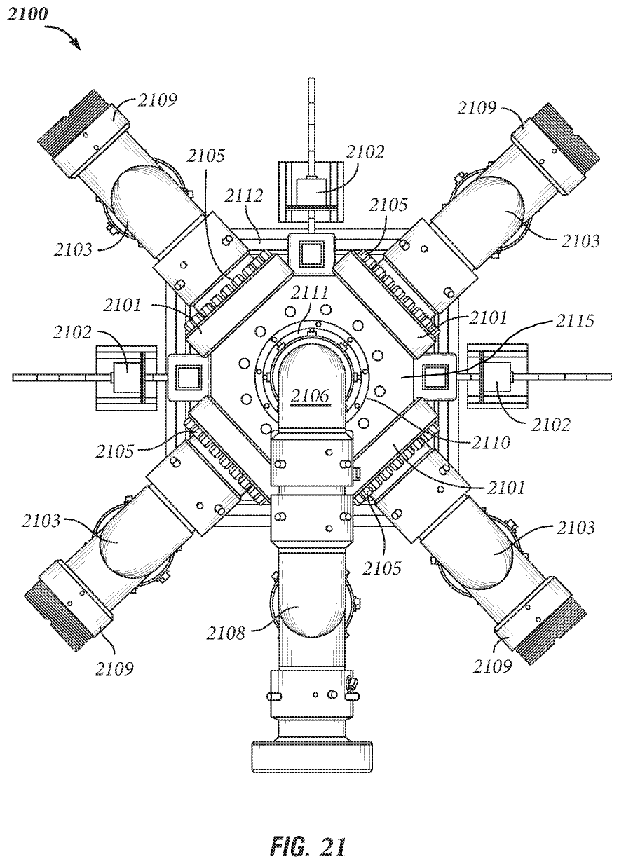

FIG. 21 is a top view of a diverter assembly 2100 connected to multiple elbow joints. The diverter body 2115 of the diverter assembly 2100 can have multiple outlet ports connected to a string of conduits that connect with a fracturing tree. Each outlet port can be coupled to an outlet flange 2101 that can be connected to an outlet joint 2103. Outlet flanges 2101 can be secured to the diverter 2115 through mounting studs 2111. Various conduits such as elbow joints 2109 or straight conduits can be then connected to the outlet joints 2103. Fluid can enter the diverter 2115 by traveling through an inlet joint that that can be coupled to other inlet conduits.

The diverter 2115 can be mounted on a base 2112 that can be raised or lowered by a lifting mechanism 2102. An internal plug can be oriented to a selected outlet port and exclude all other outlet ports from receiving fluid from a fluid source. When the plug is being oriented, a bonnet nut 2110 can be raised to allow the plug to rise. An inner plug nut 2111 can be used to align the plug with the selected outlet port by positioning the desired aperture adjacent to the desired outlet port and having a push plug inserted into the corresponding aperture on the inner plug nut. Once the plug has been oriented and aligned, the plug can then be sealed against the diverter 2115 and the bonnet nut 2110 can be lowered to hold the plug in position.

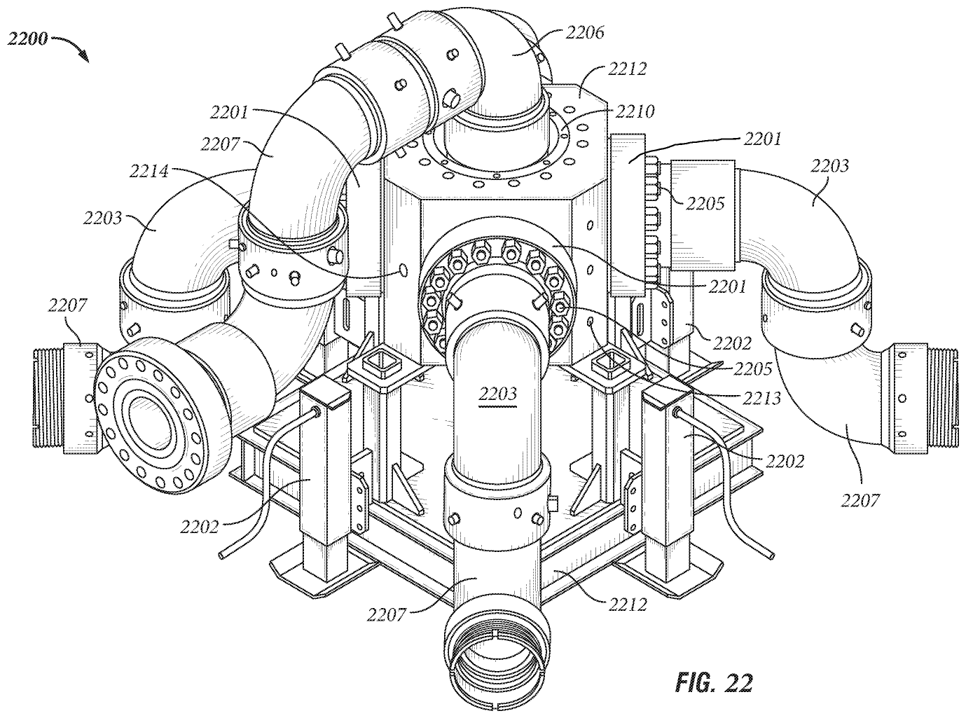

FIG. 22 is a perspective view of a diverter assembly 2200 connected to multiple elbow joints. The diverter 2212 can be mounted on a base 2212 that can be raised or lowered with a lifting mechanism 2202. Multiple outlet flanges 2201 can be coupled to the diverter 2212 with mounting studs 2205. Each of the outlet flanges 2201 can be coupled to an outlet joint 2203 that connects with other conduits such as elbow joints 2207. Fluid can travel from a fluid source, through connector conduits such as elbow joints 2207, and into an inlet joint 2203 which is coupled to the diverter 2212.

Fluid travels into the diverter 2212, and then into the selected outlet port. A bonnet nut 2210 can be raised out of the diverter 2212 when an internal plug is being raised and oriented to the selected outlet port. While the plug is raised, a wash port 2214 can be used to wash out the inner portions of the diverter 2212. This can be accomplished by pushing fluid such as water into a wash port 2214 on one side of the diverter 2212 and allowed to exit out another wash port 2214 positioned on the opposite side of the diverter 2212. This can be useful in removing residue such as sand out of the diverter 2212 after a fracturing cycle is conducted. Pressure ports 2213 can also be present on the outside of the diverter 2212. A set of pressure ports 2213 can be used to pressure test seals and a wash port 2214 can be used to push fluid through the diverter 2212 while the plug is raised to wash out debris or other contaminants.

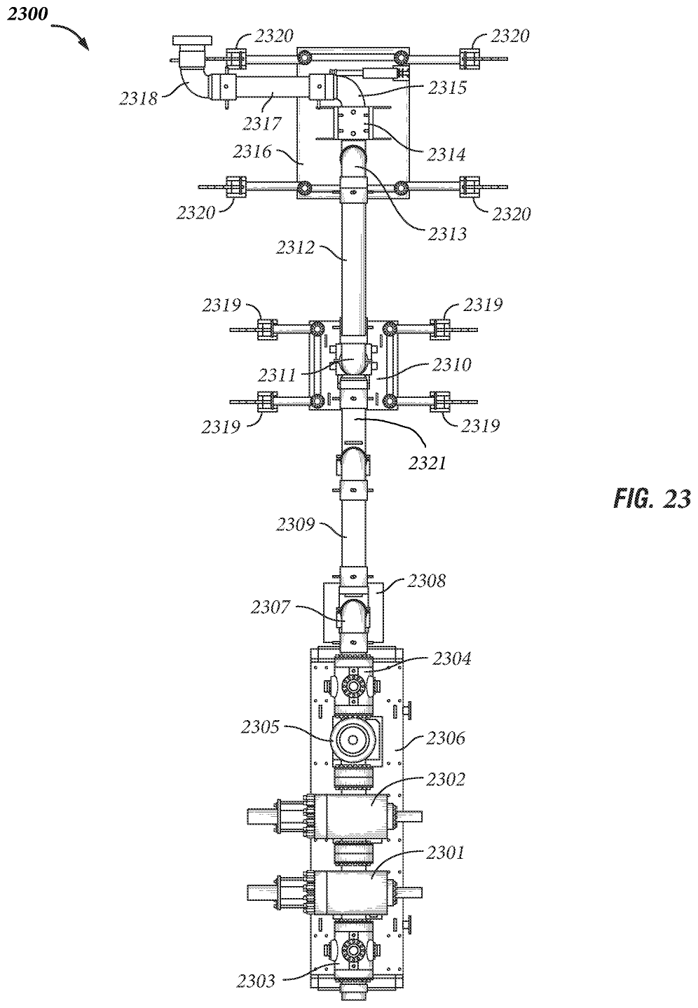

FIG. 23 is a top view of a string of conduit that can be incorporated into a hydraulic fracturing system 2300. A sled 2306 can be positioned in line with a missile trailer and a diverter so that fluid that leaves the missile trailer travels through the valves 2301, 2302, 2305, crosses 2303, 2304, and check valves that are coupled to the trailer, before traveling through a connected string of conduits. The string of conduits can consist of a wide variety of configurations of various types of conduits such as elbow joints 2307, 2311, 2313, 2315, 2318 and straight conduits 2309, 2312, 2317. These conduits can be mounted to sleds 2310, 2316 by mounting braces 2314, and the sleds 2310, 2316 can have their heights raised or lowered through lifting mechanisms 2319, 2320.

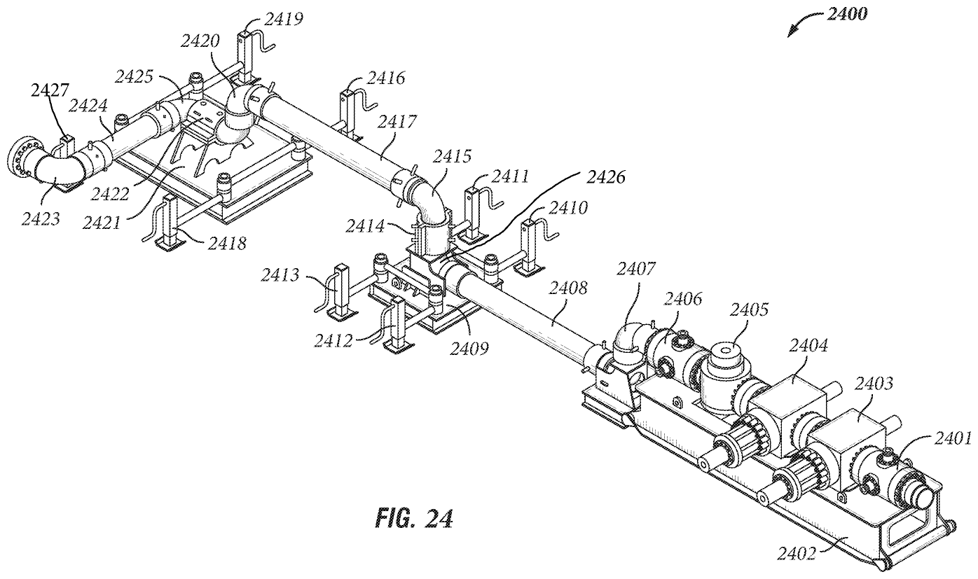

FIG. 24 is a perspective view of a string of conduit that can be incorporated into a hydraulic fracturing system 2400. Various valves 2403, 2404, 2405 crosses 2401, 2406, and check valves can be mounted on a sled 2402 that can be positioned between the missile trailer and diverter. After fluid travels through the valves 2403, 2404, 2405, crosses 2401, 2406, and check valves attached to the sled 2402, the fluid can traverse through a string of conduits that consist of multiple elbow joints 2407, 2415, 2420, 2423 and straight connectors 2408, 2417, 2424. These elbow joints 2407, 2415, 2420, 2423 and straight connectors 2408, 2417, 2424 can be mounted on sleds 2402 that can have their heights manipulated by a lifting mechanism 2412, 2413, 2410, 2411, 2416, 2418.

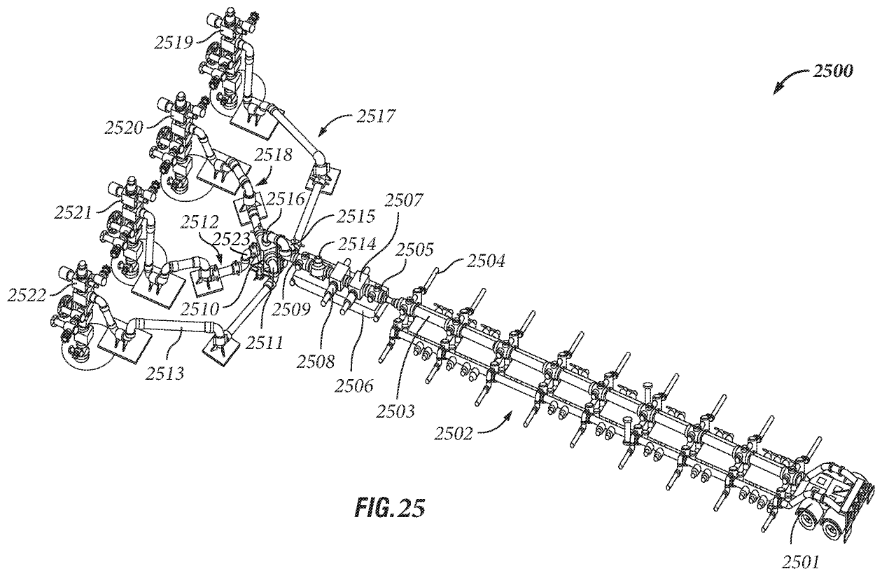

FIG. 25 is a perspective view of one embodiment of a diverter system 2500 connected to four fracturing trees. In the fracturing diverter system 2500, a missile trailer 2501 can be positioned so that it is in close proximity to wellheads on a multi well drill pad. The missile trailer 2501 can have a large conduit 2502 that can allow fluid to be directed toward the connected well heads. Along the longitudinal length of the large conduit 2502, lateral pressure conduits 2504 are positioned that can be coupled to a pressure truck. The number of lateral pressure conduits 2504 and pressure trucks connected to the missile can vary depending on the needs of the fracturing crew to properly fracture each well.

Then, fluid can travel through a sled 2506 with multiple valves 2507, 2508, 2514, crosses 2505, 2509 and check valves coupled to it that allow for control of the media entering the connected wells, as well as flowback from the wells as well. Fluid can then travel through an inlet joint 2516 and into a diverter 2510. The diverter 2510 can have the capacity to be coupled with multiple strings of conduit 2517, 2518, 2512, 2513 by outlet joints 2515, 2523, 2511 that are then connected to a corresponding fracturing tree 2519, 2520, 2521, 2522 or Christmas tree. The diverter 2510 has an internal plug that can isolate a specific outlet port so that fluid is only allowed to travel into the intended fracturing tree.

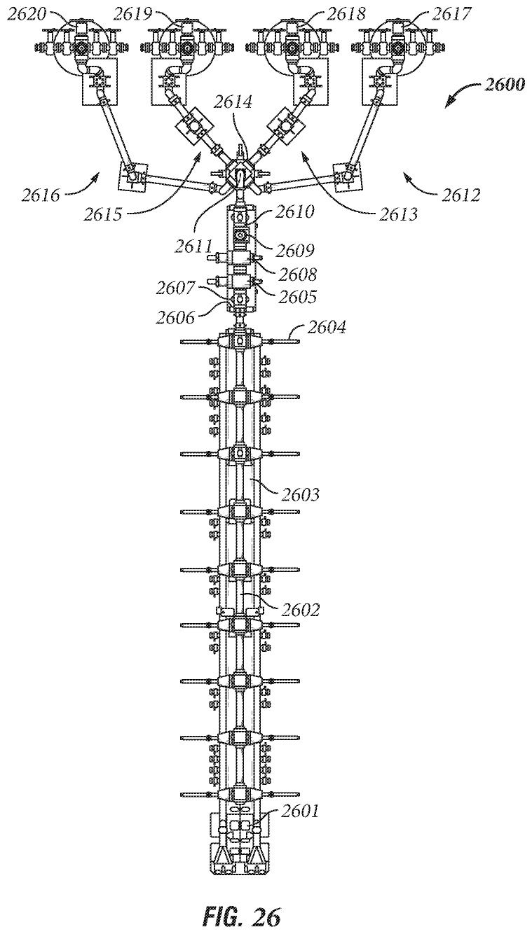

FIG. 26 is a top view of one embodiment of a diverter system connected to four fracturing trees. In a diverter system 2600, a diverter 2614 can be connected to multiple outlet ports that are connected to and in line with multiple fracturing trees 2617, 2618, 2619, 2620. Fluid from a fluid source can be directed into various valves 2605, 2608, 2609, crosses 2607, 2610 and check valves mounted onto a sled 2606 and then through an inlet joint 2611 to enter the diverter 2614. The fluid source can consist of a missile trailer 2601 that has a missile 2603 mounted on it and has a longitudinal conduit 2602 with lateral pressure conduits 2604 that allow for pressure trucks to be hooked up. The pressure trucks provide enough horsepower to put the necessary pressure on the fluid traveling through the fracturing diverter system 2600 to effectively fracture a well.

The diverter has an internal plug that can direct fluid toward a desired well and exclude all other wells without disassembling and reassembling the system. Fluid that enters the diverter 2614 can travel into the selected outlet port that corresponds with the selected well. The selected well is connected to the diverter 2614 through a string of conduits 2612, 2613, 2615, 2616 that can have various configures depending on the height and distance of the diverter 2614 from the fracturing tree 2617, 2618, 2619, 2620 coupled to the well. In the displayed embodiment, there are four fracturing trees 2617, 2618, 2619, 2620 coupled to four wells, and the diverter 2614 can alternate which one of the wells receive fluid through its coupled fracturing tree 2617, 2618, 2619, 2620.

While this disclosure has been particularly shown and described with reference to preferred embodiments, it will be understood by those skilled in the art that various changes in form and detail may be made therein without departing from the spirit and scope of the invention. The investors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called filed. Further, a description of a technology as background information is not to be construed as an admission that certain technology is prior art to any embodiments) in this disclosure. Neither is the “Brief Summary” to be considered as a characterization of the embodiments(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of the such claims shall be considered on their own merits in light of this disclosure but should not be constrained by the headings set forth herein.

We claim:

1. A diverter system comprising:
a diverter body, the diverter body having a plurality of outlet ports;
the diverter body housing a plug, the plug comprising an inlet port and a fluid channel, wherein the inlet port is coupled with the fluid channel;
a connector port in the plug in communication with the fluid channel, wherein the plug can be moved to align to connect the connector port to an individual outlet port of the plurality of outlet ports, such that when the plug is aligned with the individual outlet port, the remaining outlet ports of the plurality of outlet ports can be sealed so that fluid is allowed to only pass between the fluid channel and the connected individual outlet port of the plurality of outlet ports; and
an outlet selector configured to move the plug to align one of the plurality of outlet ports with the connector port.

2. The diverter system of claim 1 wherein the diverter body comprises a plurality of channels, wherein the plurality of channels allow for pressure to be communicated to a location on the plug.

3. The diverter system of claim 2 wherein a first channel of the plurality of channels is connected to a first fluid port for applying pressure through the first channel to a piston attached to the plug, wherein application of pressure to the first fluid port causes force to be applied to the piston, causing the plug to be pressed against the diverter body.

4. The diverter system of claim 3, further comprising a locking mechanism for locking the plug in place.

5. The diverter system of claim 4 wherein the locking mechanism comprises a retaining ring mated with the diverter body, wherein the retaining ring can be adjusted to engage the plug at a an interface to lock the plug in place in the diverter body.

6. The diverter system of claim 2 wherein a second channel of the plurality of channels is connected to a second fluid port for applying pressure through the second channel to an interface between the plug and the diverter body and wherein application of pressure to the second fluid port causes force to be applied to the plug, causing the plug to separate from the diverter body.

7. The diverter system of claim 6 wherein the interface between the plug and the diverter body is at a base of the plug below a seal that prevents fluid from leaking past the seal when pressure is applied to the second fluid port, causing pressure to be applied to the interface between the plug and the diverter body to push a body of the plug away from the diverter body.

8. The diverter system of claim 7 wherein the base of the plug is cylindrical and wherein the diverter body that mates with the base of the plug is configured to allow the plug to slide to disengage the body of the plug from the diverter body while the base of the plug is still engaged with the diverter body.

9. The diverter system of claim 1, wherein the outlet selector comprises a stem joined to the plug and extending through the diverter body such that the stem can be turned to rotate the plug.

10. The diverter system of claim 1, wherein the outlet selector comprises a plurality of holes in an exposed portion of the plug for allowing the plug to be rotated with a tool engaged with one or more of the plurality of holes.

11. The diverter system of claim 6 comprising a locking mechanism for locking the plug against the diverter, wherein the locking mechanism is configured to be disengaged which allows the plug to move up.

12. The diverter system of claim 1, further comprising a sleeve for mating with the plug between the plug and an inner wall of the diverter body, wherein the sleeve can be configured to move either with or independent of the plug.

13. The diverter of claim 12 wherein the sleeve comprises a single hole in the sleeve matching the size of the plurality of outlet ports, such that when desired the sleeve can keep one or more of the plurality of outlet ports sealed and the single hole can be placed over a desired outlet port.

14. The diverter system of claim 12 further comprising a plug retaining ring and a sleeve retaining ring, wherein the retaining ring and the sleeve retaining ring are mated together and can be moved together or independently to lock and unlock the plug retaining ring and the sleeve retaining ring.

15. The diverter system of claim 14 wherein the sleeve retaining ring comprises a first threaded interface mating with the diverter body and wherein the sleeve retaining ring can be turned to engage the sleeve to lock the sleeve in place.

16. The diverter system of claim 15 wherein the plug retaining ring comprises a second threaded interface for mating with an inner diameter of the sleeve retaining ring such that the plug retaining ring can be turned to engage the plug and lock the plug in place.

17. The diverter system of claim 1, wherein a missile is connected in fluid communication with the inlet port.

18. The diverter system of claim 17, wherein the individual outlet port is in fluid communication with a fracturing stack.

19. The diverter system of claim 17 wherein at least two of the plurality of outlet ports are each in fluid communication with one of a plurality of fracturing stacks.

20. The diverter system of claim 1 further comprising an inlet diverter comprising a connector outlet port that is coupled to the inlet port.

21. The diverter system of claim 1, wherein at least one of the outlet ports of the plurality of outlet ports is a series connector outlet port connected to a second diverter system.

22. The diverter system of claim 1, wherein the plug is configured to swivel between each of the plurality of outlet ports.

23. A method for using a diverter assembly comprising:
coupling a fluid source to an inlet port of a plug housed in a diverter body, wherein the inlet port is in fluid communication with a fluid channel;
aligning an outlet port of a plurality of outlet ports on the diverter body with a connection port on the plug using an outlet selector; and
connecting the connection port on the plug to the aligned outlet port of the plurality of outlet ports, wherein the fluid channel in the plug is in fluid communication with the aligned outlet port, and wherein the remaining outlet ports of the plurality of outlet ports are sealed so that fluid from the inlet port is directed only to the aligned outlet port.

24. The method of claim 23 further comprising:
applying pressure to a first fluid port so that pressure is communicated through a first channel to a piston attached to the plug, causing the piston to move and the body of the plug to press against the diverter body.

25. The method of claim 24 further comprising:
after the step applying pressure, locking the plug in place with a locking mechanism.

26. The method of claim 25, wherein the locking mechanism comprises a retaining ring movable with respect to the diverter body for allowing the retaining ring to be positioned against the plug to lock it in place.

27. The method of claim 24, further comprising:
applying a pressure to a second fluid port so that the pressure is communicated to an interface between the plug and the diverter body, causing a body of the plug to separate from the diverter body, wherein the interface between the plug and the diverter body is at a base of the plug below a seal that prevents fluid from leaking past the seal when pressure is applied to the second fluid port.

28. The method of claim 27 wherein the plug comprises a cylindrical base that stays engaged with diverter body after the body of the plug has separated from the diverter body during the step applying pressure to a second fluid port.

29. The method of claim 23 further comprising:
aligning a hole on a sleeve housed between the plug and the diverter body with a desired outlet port, wherein the sleeve has a plurality of holes that can be aligned simultaneously with two or more of the plurality of outlet ports, wherein when the plurality of holes are so aligned, at least one of the plurality of outlet ports is covered by the sleeve to prevent flow of fluid through the at least one plurality of outlet ports, and wherein the sleeve can be configured to move either with or independent of the plug.

30. The method of claim 29 further comprising:
locking the sleeve in place by turning a sleeve retention ring until it engages with the sleeve.

31. The method of claim 30 further comprising:
locking the plug in place by turning a plug retention ring until it engages with the plug, wherein the plug retention ring mates with the sleeve retaining ring, and can be moved with or independent of the sleeve retention ring.

32. The method of claim 23 further comprising:
connecting a missile to the inlet port.

33. The method of claim 23 further comprising:
connecting at least one outlet port of the plurality of outlet ports such that the at least one outlet port is in fluid communication with a fracturing stack.

34. The method of claim 23 further comprising:
connecting an inlet diverter such that it is in fluid communication with the inlet port.
